(19) United States
(12) Patent Application Publication
(10) Pub. No.: US 2025/0309976 A1
(43) Pub. Date: Oct. 2, 2025

(54) Active Coordination Sets for Non-Terrestrial Networks

(71) Applicant: Google LLC, Mountain View, CA (US)

(72) Inventors: Jibing Wang, San Jose, CA (US); Erik Richard Stauffer, Sunnyvale, CA (US)

(73) Assignee: Google LLC, Mountain View, CA (US)

(21) Appl. No.: 19/068,305

(22) Filed: Mar. 3, 2025

Related U.S. Application Data
(60) Provisional application No. 63/570,379, filed on Mar. 27, 2024.

(51) Int. Cl. H04B 7/185; H04W 64/00; H04W 74/0833

(52) U.S. Cl. CPC H04B 7/18519; H04W 64/00; H04W 74/0833

(57) ABSTRACT

In aspects, a coordinating base station that forms an active coordination set (ACS) is described that includes at least the coordinating base station and a non-terrestrial network base station (NTN BS) for joint-communication with a user equipment (UE). Based on an evaluation of terrestrial channel conditions for the UE, the coordinating base station selects one or more non-terrestrial NTN BSs as candidate base stations to add to the ACS. The coordinating base station transmits ephemeris information for the one or more NTN BSs to the UE. The UE acquires and measures signal quality of each of the NTN BSs and sends an indication to the coordinating base station. Based on the indication, the coordinating base station sends an invitation to the NTN BS to join the ACS which communicates using timing and frequency compensation to compensate for distance and Doppler effects.

### CROSS-REFERENCE TO RELATED APPLICATION(S)

This application claims the benefit of U.S. Provisional Patent Application Ser. No. 63/570,379 filed on Mar. 27, 2024, the disclosure of which is incorporated by reference herein in its entirety.

### BACKGROUND

Non-terrestrial communication systems, such as satellite-based communication systems, provide flexibility to end-users. To illustrate, a single satellite that acts as a relay can provide coverage to remote locations that are difficult to reach, such as mountainous or oceanic areas with limited accessibility. However, non-terrestrial communications also pose challenges. For example, a user equipment (UE) may experience difficulties establishing and/or maintaining a wireless link with a satellite due to the orbital velocity of the satellite, which may adversely impact the services provided through the non-terrestrial communication system (e.g., poor signal quality, increased bit errors). However, there are opportunities to improve quality and/or reliability of services provided by non-terrestrial communication systems that utilize active coordination sets that can combine terrestrial and non-terrestrial networks.

### SUMMARY

In aspects, methods, devices, systems, and means for active coordination sets for non-terrestrial networks describe a coordinating base station that forms an active coordination set (ACS) including, at least, the coordinating base station for joint-communication with a user equipment (UE) Based on an evaluation of terrestrial channel conditions for the UE, the coordinating base station selects one or more non-terrestrial network base stations (NTN BSs) as candidate base stations to add to the ACS. The coordinating base station transmits ephemeris information for the one or more NTN BSs to the UE. The coordinating base station receives an indication from the UE regarding acceptance of at least one of the candidate NTN BSs. The coordinating base station sends the UE's rough location information to the NTN BS that directs the NTN BS to precompensate for propagation delay and/or Doppler shift during downlink joint-transmissions in the ACS and compensate for propagation delay and/or Doppler shift during uplink joint-receptions in the ACS. In aspects, methods, devices, systems, and means for active coordination sets for non-terrestrial networks describe a coordinating base station that requests system information from a second NTN BS. The coordinating base station receives, from the second NTN BS, the ephemeris information, system information and configuration information for triggering the second NTN BS to join the ACS. The coordinating base station transmits, to a user equipment (UE) the ephemeris information and the configuration information for triggering the second NTN BS to join the ACS. The coordinating base station, based on receiving the configuration information for triggering the second NTN BS to join the ACS from the UE. The coordinating base station communicates with the second NTN BS to form the ACS. The coordinating base station communicates with the second NTN BS to coordinate delay and Doppler compensation for the ACS. The coordinating base station jointly-communicates with the UE using the coordinated delay and Doppler compensation.

The details of one or more implementations are set forth in the accompanying drawings and the following description. Other features and advantages will be apparent from the description, drawings, and examples described herein. This summary is provided to introduce subject matter that is further described in the Detailed Description and Drawings. Accordingly, this summary should not be considered to describe essential features nor used to limit the scope of the described subject matter.

### BRIEF DESCRIPTION OF THE DRAWINGS

The details of one or more aspects of active coordination sets for non-terrestrial networks are described below. The use of the same reference numbers in different instances in the description and the figures may indicate like elements:

FIG. 1 illustrates an example environment that can be used in accordance with various aspects of active coordination sets for non-terrestrial networks;

FIG. 2 illustrates an example device diagram of entities that can implement various aspects of active coordination sets for non-terrestrial networks;

FIG. 3 illustrates an example device diagram of entities that can implement various aspects of active coordination sets for non-terrestrial networks;

FIG. 4 illustrates an example wireless network protocol stack that can be used in accordance with one or more aspects of active coordination sets for non-terrestrial networks;

FIG. 5 illustrates example air interface resources that can be used in accordance with various aspects of active coordination sets for non-terrestrial networks;

FIG. 6 illustrates an example environment that can be used in accordance with various aspects of active coordination sets for non-terrestrial networks;

FIGS. 7a and 7b illustrate example signaling and control transaction diagrams that can be used to perform aspects of active coordination sets for non-terrestrial networks;

FIG. 8 illustrates another example signaling and control transaction diagram that can be used to perform aspects of active coordination sets for non-terrestrial networks;

FIGS. 9a and 9b illustrate example methods in accordance with various aspects of active coordination sets for non-terrestrial networks; and

FIG. 10 illustrates an example method in accordance with various aspects of active coordination sets for non-terrestrial networks.

### DETAILED DESCRIPTION

A non-terrestrial network (NTN) can provide ubiquitous coverage for user equipment (UE) communications using non-terrestrial flying or floating communication platforms (e.g., low earth orbit (LEO), medium earth orbit (MEO), geostationary earth orbit (GEO), and/or highly elliptical orbiting (HEO) satellites; airborne vehicle or aircraft-based communication platforms, drone-based communication platforms, and/or an uncrewed aerial vehicle- (UAV-) based communication platform). Although an NTN platform may be implemented as any of the aforementioned platforms, for simplicity these NTN platforms will be referred to as satellites. One of these non-terrestrial flying or floating communication platforms may be referred to as a High Altitude Platform Station (HAPS). Depending on hardware configuration, a HAPS can operate in higher frequency bands (e.g., above-6 GHz bands, bands that are defined by one or more of the 3GPP LTE, 5G NR, or 6G communication standards such as 26 GHz, 28 GHz, 38 GHz, 39 GHz, 41 GHz, 57-64 GHz, 71 GHz, 81 GHz, 92 GHz bands, 100 GHz to 300 GHz, 130 GHz to 175 GHz, or 300 GHz to 3 THz bands). UE communications with an NTN poses several challenges for UE mobility. For example, a UE may experience difficulties establishing and/or maintaining a wireless link with a non-terrestrial network base station (NTN BS) due to the motion of the NTN BS, such as the orbital velocity of a satellite or interference between the NTN and a terrestrial network (TN), if the same frequency is used by both the NTN and the TN. These difficulties may adversely impact the services provided to the UE (e.g., poor signal-quality, increased bit errors). For instance, wireless signal transmissions to or from a fast-moving satellite may result in Doppler and/or delay shifts at the receiver side that degrade a signal quality. As another example, a fast-moving satellite may only be within transmission/reception range over a small window of time (e.g., 10 to 20 minutes), where signal quality degrades at the edges of the transmission/reception range.

In some aspects, regulatory bodies, such as the Federal Communications Commission (FCC) or the International Telecommunication Union (ITU), may limit the power densities of non-terrestrial transmissions in the corresponding radio frequency (RF) bands to mitigate interference issues. A regulated power density for an RF band can limit the effectiveness of a particular operating scenario, such as when a UE operates at the edge of a cell. As yet another challenge, UEs have constrained space for energy storage and hardware, which may impact how the UEs implement support for the non-terrestrial communications. For instance, the constrained space may not provide sufficient room for a parabolic and/or dish antenna. These various factors and challenges may result in poor signal quality for the non-terrestrial communications and culminate into unreliable communications (e.g., dropped calls, bit errors).

While features and concepts of the described systems and methods for active coordination sets for non-terrestrial networks can be implemented in any number of different environments, systems, devices, and/or various configurations, various aspects of active coordination sets for non-terrestrial networks are described in the context of the following example devices, systems, and configurations.

### Operating Environment

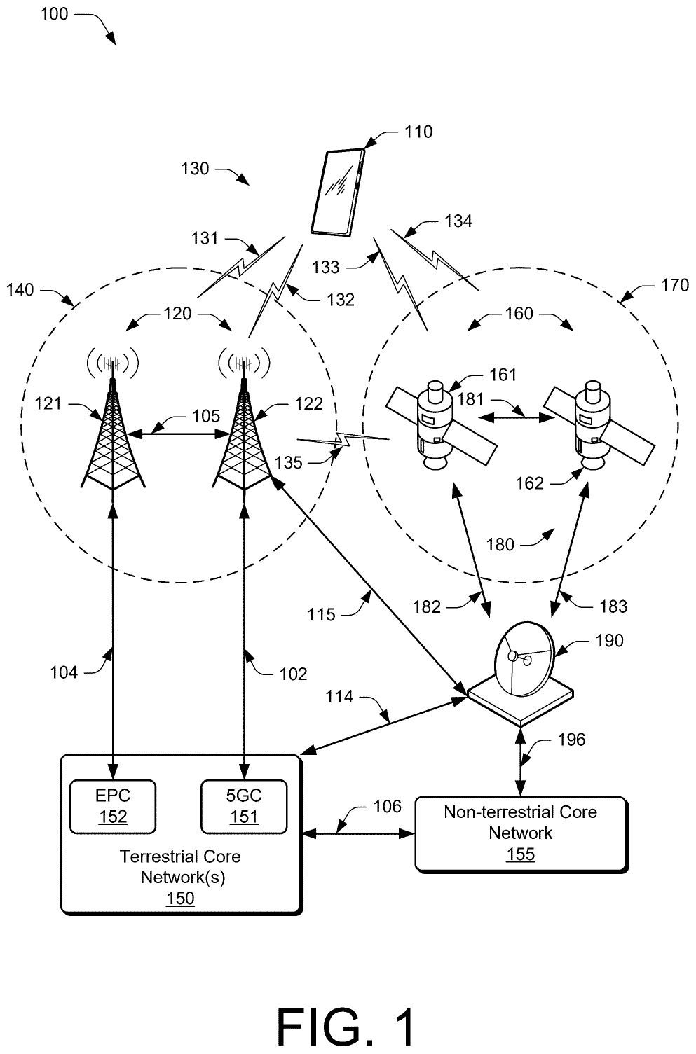

FIG. 1 illustrates an example environment 100, which includes a user equipment 110 (UE 110) that can communicate with terrestrial base stations 120 (TN BS 120) (illustrated as terrestrial base stations 121 and 122) through one or more wireless communication links 130 (wireless links 130), generally illustrated as wireless link 131 and wireless link 132. Alternatively or additionally, the UE 110 can communicate with one or more non-terrestrial communication platforms (non-terrestrial base stations, NTN BSs), illustrated as NTN BSs 160 (e.g., NTN BS 161 and NTN BS 162) through one or more of the wireless links 130, generally illustrated as wireless service link 133 and wireless service link 134. In one alternative, the NTN BS 160 implements a transparent (bent-pipe) architecture in which the satellite acts as a transponder relay to relay messages between the UE 110 and the ground station 190. In the transparent architecture the satellite includes RF filtering, frequency conversion, and amplification. In another alternative, an NTN BS 160 can implement a regenerative architecture in which RF filtering, frequency conversion and amplification along with demodulation/decoding, switch and/or routing, coding/modulation is included in the satellite. This is effectively equivalent to having all or some part of gNB functions on board the satellite such as using distributed base station functionality, such as a Distributed Unit (DU), that communicates with a Central Unit (CU) at the ground station 190.

For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The terrestrial base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination thereof.

The terrestrial base stations 120 communicate with the UE 110 using the wireless links 131 and/or 132, which may be implemented as any suitable type of wireless link. Similarly, the NTN BS 160 communicate with the UE 110 using the wireless feeder links 133 and/or 134. At times, the terrestrial base stations 120 communicate with the NTN BSs 160 using the wireless link 135. The wireless links 131, 132, 133, 134, and/or 135 include control-plane signaling and/or user-plane data, such as downlink of user-plane data and control-plane information communicated from the terrestrial base stations 120 to the UE 110, downlink of user-plane data and control-plane information from the NTN BSs 160 to the UE 110, uplink of other user-plane data and control-plane information communicated from the UE 110 to the terrestrial base stations 120, uplink of other user-plane data and control-plane signaling communicated from the UE 110 to the NTN BSs 160, downlink and uplink communications between a base station and an NTN BS, or any combination thereof. The wireless links 130 may include one or more wireless links (e.g., radio links) or bearers implemented using any suitable communication protocol or standard, or combination of communication protocols or standards, such as Third Generation Partnership Project Long-Term Evolution (3GPP LTE), Fifth Generation New Radio (5G NR), Mobile Satellite Service (MSS), and future evolutions.

In various aspects, the terrestrial base stations 120 and UE 110 may be implemented for operation in sub-gigahertz bands, sub-6 GHz bands (e.g., Frequency Range 1), and/or above-6 GHz bands (e.g., Frequency Range 2, millimeter wave (mmWave) bands) that are defined by one or more of the 3GPP LTE, 5G NR, or 6G communication standards. Multiple wireless links 130 may be aggregated using a carrier aggregation or multi-connectivity technology to provide a higher data rate for the UE 110. Multiple wireless links 130 from multiple terrestrial base stations 120 or NTN BS 160 may be configured for Coordinated Multipoint (CoMP) or Dual Connectivity (DC) communication with the UE 110.

The terrestrial base stations 120 form a first wireless communication network, such as a Radio Access Network 140 (e.g., RAN, Evolved Universal Terrestrial Radio Access Network, E-UTRAN, 5G NR RAN, NR RAN), where the RAN 140 communicates with one or more terrestrial core networks 150 (core network 150). To illustrate, the terrestrial base station 121 connects, at interface 102, to a 5G core network 151 (5GC 151)) through an NG2 interface for control-plane signaling and using an NG3 interface for user-plane data communications. The terrestrial base station 122 connects, at interface 104, to an Evolved Packet Core 152 (EPC 152) using an S1 interface for control-plane signaling and user-plane data communications. Alternatively, or additionally, the terrestrial base station 122 connects to the 5GC 151 using an NG2 interface for control-plane signaling and through an NG3 interface for user-plane data communications. Accordingly, certain terrestrial base stations 120 can communicate with multiple wireless core networks 150 (e.g., the 5GC 151, the EPC 152).

In addition to connections with core networks, the terrestrial base stations 120 may communicate with each other. For example, the terrestrial base stations 121 and 122 communicate through an Xn interface at interface 105. In some aspects, a terrestrial base station 120 coordinates with an NTN BS 160 through the wireless link 135 and/or through the connection to the terrestrial core network 150. As another example, a terrestrial core network 150 coordinates with a non-terrestrial core network 155 through an interface 106 as further described.

The NTN base station (NTN BS) 160 (e.g., a satellite implementing either transparent or regenerative architecture) form a second wireless communication network, generally labeled in the environment 100 as a non-terrestrial access network 170 (NTN 170). In aspects, the UE 110 communicates with the NTN BSs using the wireless links 133 and/or 134 that can be implemented using a common radio-access technology (RAT) used to communicate with the terrestrial base stations 120 and/or an NTN RAT different from RATs used to communicate with the terrestrial base stations 120. As one example, the RAT used to communicate with the NTN BSs 160 may operate in accordance with frequencies and protocols associated with a Mobile Satellite Service (MSS) or the like. Alternatively or additionally, the UE 110 communicates with the NTN BSs 160 using one or more RATs used to communicate with the terrestrial base stations 120, such as LTE, 5G NR, 6G communications, and so forth.

Generally, the NTN BS 161 and NTN BS 162 represent non-terrestrial communication platforms and are part of an NTN as described previously. The NTN BS 161 and the NTN BS 162 can include on-board processing to implement base station functionality (e.g., a gNode B, a Distributed Unit (DU)) in a regenerative architecture and/or implement a bent-pipe architecture in which the NTN BS acts as a transponder relay in a transparent architecture. The NTN BS 161 and the NTN BS 162 communicate with elements of the NTN 170 by way of one or more interfaces 180 (illustrated as interface 181, interface 182, and interface 183). Interface 181 supports an inter-NTN BS link (such as an inter-satellite link (ISL)) connecting NTN BS 161 and NTN BS 162 and may be, for example, an optical interface, a laser interface, or a radio-frequency (RF) interface. In one example, if the NT NBS 161 supports a transparent architecture, the interface 182 supports feeder links such as gateway links (GWLs) connecting NTN BS 161, to a non-terrestrial core network 155, such as through one or more ground stations 190 (e.g., remote radio units (RRUs)) and interface 196. In another example, if the NTN BS 162 supports a regenerative architecture, the interface 183 may be an F1 interface with the NTN BS 162 acting as a Distributed Unit (DU) of a distributed base station and the ground station 190 acting as a Central Unit (CU) of a distributed base station. The non-terrestrial core network 155 can include and/or communicate with any combination of ground stations (e.g., ground stations 190), servers, routers, switches, control elements, and the like. As shown, the non-terrestrial core network 155 communicates with the terrestrial core network 150 through an interface 106 and the ground station 190 through the interface 196 (e.g., N1, N2, and/or N3 interface). In different configurations, however, a ground station 190 may connect to a terrestrial core network through interface 114 (e.g., N1, N2, and/or N3 interface) or to a terrestrial base station 120 through a different interface 193 (illustrated generally in FIG. 1 as an interface to terrestrial base station 122). In a further configuration, the non-terrestrial core network 155 can be included in the terrestrial core network 150.

In aspects, an Active Coordination Set (ACS) is a user equipment-specific set of terrestrial base stations 120 and/or NTN BSs 160 that are determined by the user equipment to be usable for wireless communication. More specifically, the base stations and/or NTN BSs in the ACS are usable for joint transmission and/or reception (joint communication) between the user equipment and one or more of the base stations and/or NTN BSs in the ACS. The joint transmission and/or reception techniques includes CoMP, Single Radio Access Technology (RAT) Dual Connectivity (single-RAT DC), and/or Multi-Radio Access Technology Dual Connectivity (MR-DC). Joint communication includes communication between the user equipment and multiple base stations and/or NTN BS, or communication between the user equipment and multiple sectors of a single base station. The joint communication includes communication in a single radio frequency band or communication in multiple radio frequency bands.

### Example Devices

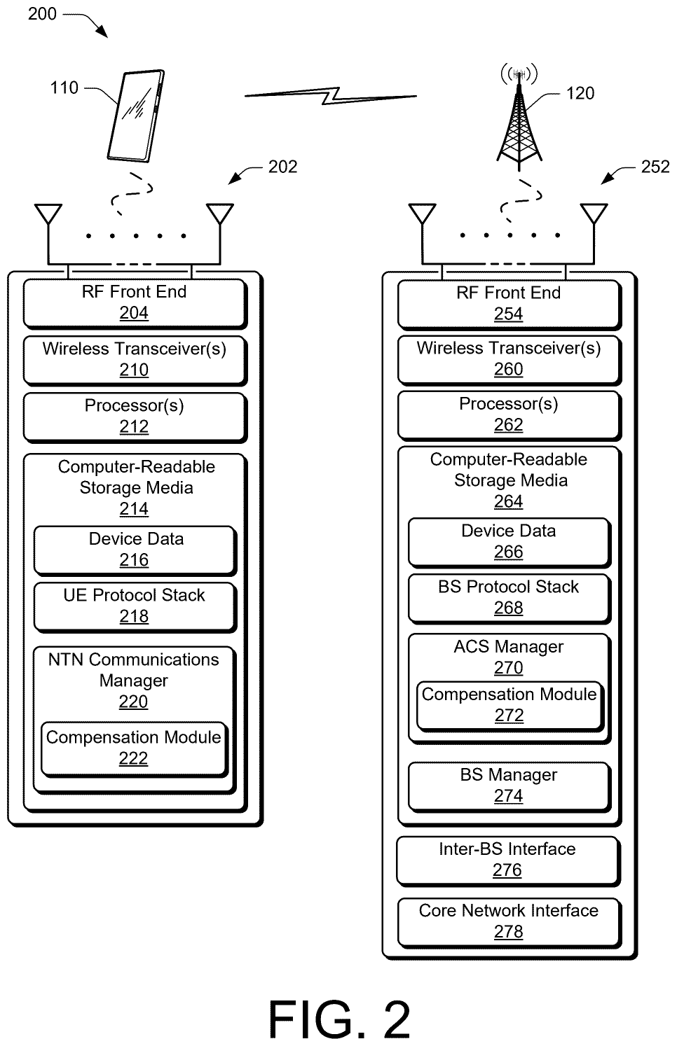

FIG. 2 illustrates an example device diagram 200 of the UE 110 and one of the terrestrial base stations 120 that can implement various aspects of active coordination sets for non-terrestrial networks. The UE 110 and/or the terrestrial base station 120 may include additional functions and interfaces that are omitted from FIG. 2 for the sake of clarity.

The UE 110 includes antennas 202, a radio frequency front end 204 (RF front end 204), and one or more wireless transceiver 210 (e.g., an LTE transceiver, a 5G NR transceiver, and/or a 6G transceiver) for communicating with the terrestrial base station 120 in the RAN 140 and/or the NTN BS 160 in the NTN 170. The RF front end 204 of the UE 110 can couple or connect the wireless transceiver 210 to the antennas 202 to facilitate various types of wireless communication. The antennas 202 of the UE 110 may include an array of multiple antennas that are configured in a manner similar to or different from each other. The antennas 202 and the RF front end 204 can be tuned to, and/or be tunable to, one or more frequency bands defined by the 3GPP LTE communication standards, 5G NR communication standards, 6G communication standards, and/or various satellite frequency bands, such as the L-band (1-2 Gigahertz (GHz)), the S-band (2-4 GHz), the C-band (4-8 GHz), the X-band (8-12 GHz), the Ku-band (12-18 GHz), K-band (18-27 GHz), and/or the Ka-band (27-40 GHz), and implemented by the wireless transceiver 210. In some aspects, the satellite frequency bands overlap with the 3GPP LTE-defined, 5G NR-defined, and/or 6G-defined frequency bands. Additionally, the antennas 202, the RF front end 204, and/or the wireless transceiver 210 may be configured to support beamforming for the transmission and reception of communications with the terrestrial base station 120 and/or the NTN BS 160. By way of example and not limitation, the antennas 202 and the RF front end 204 can be implemented for operation in sub-gigahertz (GHz) bands, sub-6 GHz bands, and/or above 6 GHz bands that are defined by the 3GPP LTE, 5G NR, 6G, and/or satellite communications (e.g., satellite frequency bands).

The UE 110 also includes one or more processor(s) 212 and computer-readable storage media 214 (CRM 214). The processor(s) 212 may be single-core processor(s) or multiple-core processor(s) composed of a variety of materials, for example, silicon, polysilicon, high-K dielectric, copper, and so on. The computer-readable storage media described herein excludes propagating signals. CRM 214 may include any suitable memory or storage device such as random-access memory (RAM), static RAM (SRAM), dynamic RAM (DRAM), non-volatile RAM (NVRAM), read-only memory (ROM), or Flash memory useable to store device data 216 of the UE 110. The device data 216 can include user data, sensor data, control data, automation data, multimedia data, beamforming codebooks, applications, and/or an operating system of the UE 110, some of which are executable by the processor(s) 212 to enable user-plane data, control-plane information, and user interaction with the UE 110.

The CRM 214 of the UE 110 includes the UE protocol stack 218. The UE protocol stack 218 may be implemented in whole or part as hardware logic or circuitry integrated with or separate from other components of the UE 110. The UE protocol stack 218 may implement any suitable type of communication protocol, such as in a manner similar to the example wireless network stack model 400 described with reference to FIG. 400. In some aspects, the UE protocol stack 218 implements one or more features of active coordination sets for non-terrestrial networks.

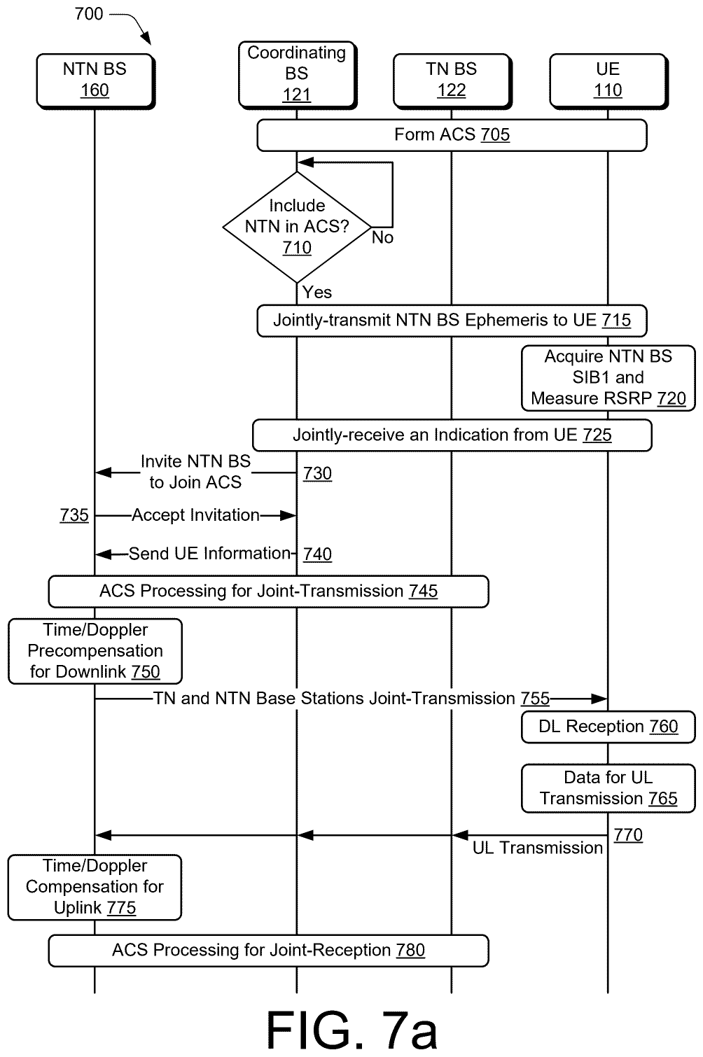

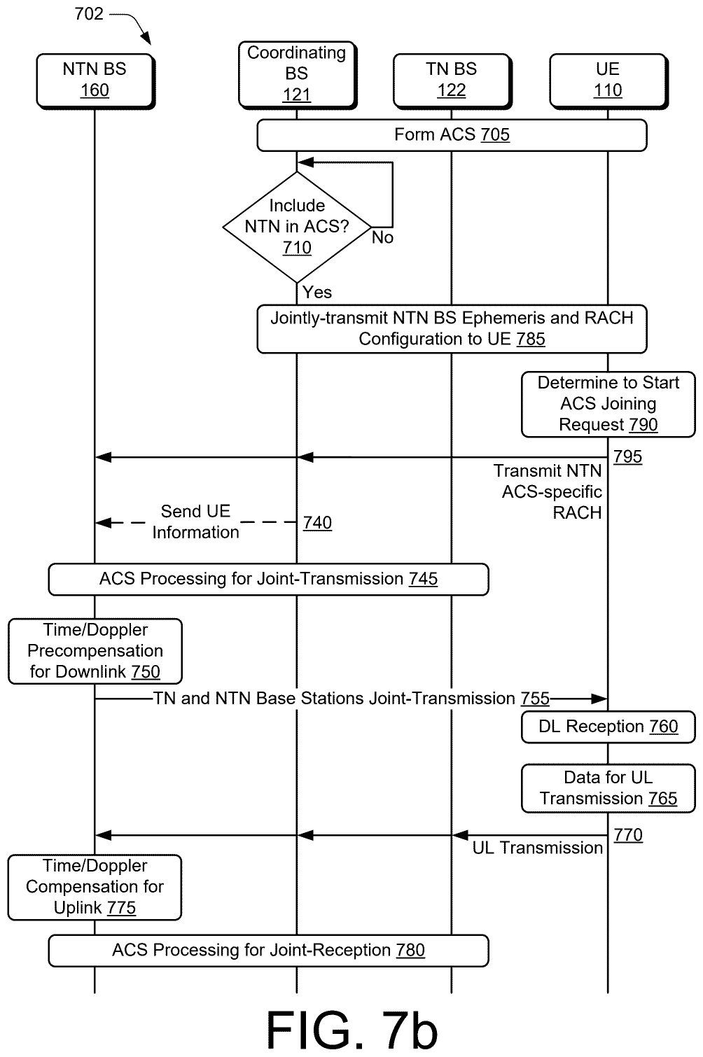

The CRM 214 of the UE 110 includes an NTN communications manager 220. The NTN communications manager 220 may be implemented in whole or part as hardware logic or circuitry integrated with or separate from other components of the UE 110. While shown separately in the diagram 200, some implementations include portions or all functionality provided by the UE NTN communications manager 220 within the UE protocol stack 218. In some aspects, the NTN communications manager 220 includes a compensation module 222 that may implement aspects of frequency and/or timing compensation when engaged with NTN BSs during joint-communication with an ACS, as described with reference to FIGS. 7-10.

The device diagram for the terrestrial base station 120, shown in FIG. 2, includes a single network node (e.g., a gNode B). The functionality of the terrestrial base station 120 may be distributed across multiple network nodes or devices and may be distributed in any fashion suitable to perform the functions described herein. The nomenclature for this distributed base station functionality varies and includes terms such as Central Unit (CU), Distributed Unit (DU), Baseband Unit (BBU), Remote Radio Head (RRH), Radio Unit (RU), and/or Remote Radio Unit (RRU). The terrestrial base station 120 includes antennas 252, a radio frequency front end 254 (RF front end 254), one or more wireless transceivers 260 (e.g., one or more LTE transceivers, one or more 5G NR transceivers, and/or one or more 6G transceivers) for communicating with the UE 110 and/or the NTN BS 160. The RF front end 254 of the terrestrial base station 120 can couple or connect the wireless transceivers 260 to the antennas 252 to facilitate various types of wireless communication. The antennas 252 of the terrestrial base station 120 may include an array of multiple antennas that are configured in a manner similar to, or different from, each other. The antennas 252 and the RF front end 254 can be tuned to, and/or be tunable to, one or more frequency bands defined by the 3GPP LTE, 5G NR, 6G communication standards, and/or various satellite frequency bands, and implemented by the wireless transceivers 260. Additionally, the antennas 252, the RF front end 254, and the wireless transceivers 260 may be configured to support beamforming (e.g., Massive multiple-input, multiple-output (Massive-MIMO)) for the transmission and reception of communications with the UE 110 and/or the NTN BS 160.

The terrestrial base station 120 also includes processor(s) 262 and computer-readable storage media 264 (CRM 264). The processor 262 may be a single-core processor or a multiple-core processor composed of a variety of materials, for example, silicon, polysilicon, high-K dielectric, copper, and so on. CRM 264 may include any suitable memory or storage device such as random-access memory (RAM), static RAM (SRAM), dynamic RAM (DRAM), non-volatile RAM (NVRAM), read-only memory (ROM), or Flash memory useable to store device data 266 of the terrestrial base station 120. The device data 266 can include network scheduling data, radio resource management data, beamforming codebooks, applications, and/or an operating system of the terrestrial base station 120, which are executable by processor(s) 262 to enable communication with the UE 110, the NTN BS 160, and/or the ground station 190.

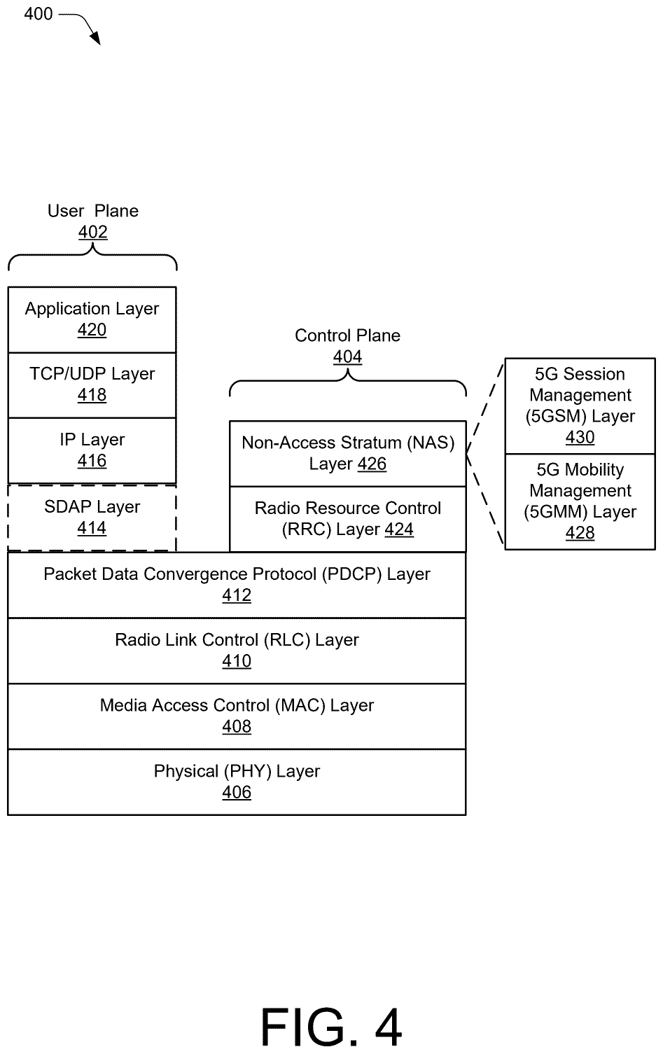

The CRM 264 includes a base station protocol stack 268 (BS protocol stack 268). The BS protocol stack 268 may be implemented in whole or part as hardware logic or circuitry integrated with or separate from other components of the terrestrial base station 120. The BS protocol stack 268 may implement any suitable type of communication protocol, such as in a manner similar to the example wireless network stack model 400 described with reference to FIG. 4.

The CRM 264 optionally includes an ACS manager 270. The ACS manager 270 may be implemented in whole or part as hardware logic or circuitry integrated with or separately from other components of the terrestrial base station 120. While shown as separate in the diagram 200, some implementations include portions or all functionality provided by the ACS manager 270 within the BS protocol stack 268. In some aspects, the ACS manager 270 manages communications and/or coordination with other TN BSs as well as NTN BSs. To illustrate, the ACS manager 270 includes a compensation module 272 that may implement aspects of frequency and/or timing compensation across base stations in an ACS, as described with reference to FIGS. 7-10.

The CRM 264 of the terrestrial base station 120 also includes a base station manager 274 (BS manager 274), which may control various functionalities of the terrestrial base station 120. Alternatively or additionally, the BS manager 274 may be implemented in whole or in part as hardware logic or circuitry integrated with, or separate from, other components of the terrestrial base station 120. In at least some aspects, the BS manager 274 configures the wireless transceivers 260 for communication with the UE 110, the NTN BS 160, and/or core network(s) (e.g., the terrestrial core network 150, the non-terrestrial core network 155). The terrestrial base station 120 also includes an inter-base station interface 276, such as an Xn and/or X2 interface, which the base station manager configures to exchange user-plane data, control-plane information, and/or other data/information between other base stations, to manage the communication of the terrestrial base station 120 with the UE 110 and/or the NTN BS 160. The terrestrial base station 120 includes a core network interface 278 that the base station manager 274 configures to exchange user-plane data, control-plane information, and/or other data/information with core network functions and/or entities.

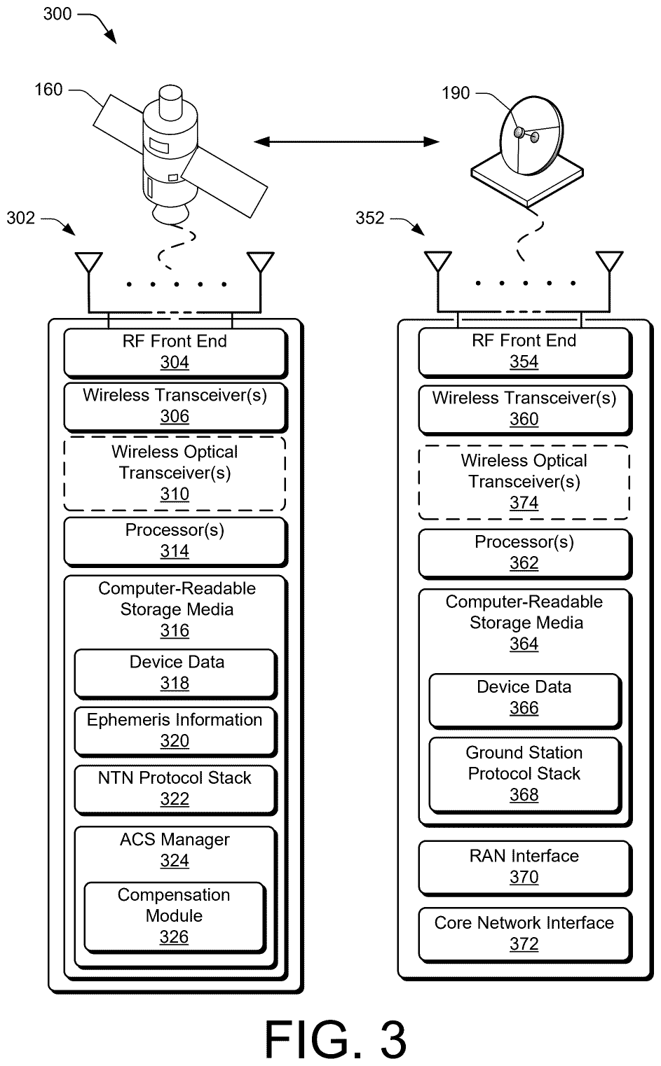

FIG. 3 illustrates an example device diagram 300 of the NTN BS 160 and the ground station 190 (alternately a non-terrestrial base station) that can implement various aspects of active coordination sets for non-terrestrial networks. The NTN BS 160 and the ground station 190 may include additional functions and interfaces that are omitted from FIG. 3 for the sake of visual clarity.

The NTN BS 160 can include on-board processing to implement a single network node (e.g., a gNode B). Alternatively or additionally, the NTN BS 160 implements a regenerative architecture with distributed base station functionality, such as a Distributed Unit (DU), that communicates with a Central Unit (CU) at the ground station 190. In some aspects, the NTN BS 160 implements a transparent (bent-pipe) architecture in which the satellite acts as a transponder relay to relay messages between the UE 110 and the ground station 190. The NTN BS 160 includes one or more antenna(s) 302, a radio frequency front end 304 (RF front end 304), and one or more wireless transceivers 306 for wirelessly communicating with the base station 120, the UE 110, another NTN BS 160, and/or the ground station 190.

The antenna(s) 302 of the NTN BS 160 may include an array of multiple antennas that are configured in a manner similar to or different from each other. Additionally, the antennas 302, the RF front end 304, and the transceiver(s) 306 may be configured to support beamforming for the transmission and reception of communications with the base stations 120, the UE 110, another NTN BS 160, and/or the non-terrestrial core network 155. By way of example and not limitation, the antennas 302 and the RF front end 304 can be implemented for operation in sub-gigahertz bands, sub-6 GHz bands, and/or above 6 GHz bands. To illustrate, the antennas 302 and the RF front end 304 can be implemented for operation in any combination of satellite frequency bands (e.g., L-band, S-band, C-band, X-band, Ku-band, K-band, Ka-band). Thus, the antenna 302, the RF front end 304, and the transceiver(s) 306 provide the NTN BS 160 with an ability to receive and/or transmit communications with the base station 120, the UE 110, another NTN BS 160, and/or the non-terrestrial core network 155.

The NTN BS 160 optionally includes one or more wireless optical transceiver 310 (wireless optical transceiver(s) 310) that can be used to communicate with other devices. To illustrate, a first instance of the NTN BS 160 communicates with a second instance of the NTN BS 160 using the wireless optical transceiver 310 as part of the interface 181.

The NTN BS 160 includes one or more processor(s) 314 and computer-readable storage media 316 (CRM 316). The processor(s) 314 may be single-core processor(s) or multiple-core processor(s) implemented with a homogenous or heterogeneous core-structure. The computer-readable storage media described herein excludes propagating signals. CRM 316 may include any suitable memory or storage device such as RAM, SRAM, DRAM, NVRAM, ROM, or Flash memory useable to store device data 318 of the NTN BS 160. The device data 318 includes user data, multimedia data, applications, and/or an operating system of the NTN BS 160, which are executable by the processor(s) 314 to enable various aspects of active coordination sets for non-terrestrial networks as further described. The CRM 316 includes ephemeris information 320 that provides information regarding the position and movements path of the NTN BS 160 for use in the determination of ACS configurations and joint-communication as described with respect to FIGS. 7-10.

In aspects of active coordination sets for non-terrestrial networks, the CRM 316 of the NTN BS 160 includes an NTN BS protocol stack 322. The NTN BS protocol stack 322 may be implemented in whole or part as hardware logic or circuitry integrated with or separate from other components of the NTN BS 160. The NTN BS protocol stack 322 may implement any suitable type of communication protocol, such as in a manner similar to the example wireless network stack model 400 described with reference to FIG. 4.

The CRM 316 includes an ACS manager 322. The ACS manager 324 may be implemented in whole or part as hardware logic or circuitry integrated with or separate from other components of the NTN BS 160. While shown as separate in the diagram 300, some implementations include portions or all functionality provided by the ACS manager 324 within the NTN BS protocol stack 322. The ACS manager 324 includes a compensation module 326 that may implement aspects of frequency and/or timing compensation when engaged with TN BS(s) and/or other NTN BS(s) during joint-communication with an ACS, as described with reference to FIGS. 7-10.

The device diagram for the ground station 190, shown in FIG. 3, can implement a single network node (e.g., a gNode B). At times, the functionality of the ground station 190 may be distributed across multiple network nodes or devices and may be distributed in any fashion suitable to perform the functions described herein. The nomenclature for this distributed base station functionality varies and includes terms such as Central Unit (CU), Distributed Unit (DU), Baseband Unit (BBU), Remote Radio Head (RRH), Radio Unit (RU), and/or Remote Radio Unit (RRU). The ground station 190 includes antennas 352, a radio frequency front end 354 (RF front end 354), one or more wireless transceivers 360 (e.g., one or more LTE transceivers, one or more 5G NR transceivers, and/or one or more 6G transceivers) for communicating with the NTN BS 160. The RF front end 354 of the ground station 190 can couple or connect the wireless transceivers 360 to the antennas 352 to facilitate various types of wireless communication. The antennas 352 of the ground station 190 may include an array of multiple antennas that are configured in a manner similar to, or different from, each other. The antennas 352 and the RF front end 354 can be tuned to, and/or be tunable to, one or more satellite frequency bands and/or frequency bands defined by the 3GPP LTE communication standards, 5G NR communication standards, 6G communication standards, and/or various satellite frequency bands, and implemented by the wireless transceivers 360. Additionally, the antennas 352, the RF front end 354, and/or the wireless transceivers 360 may be configured to support beamforming (e.g., Massive multiple-input, multiple-output (Massive-MIMO)) for the transmission and reception of communications with the NTN BS 160.

The ground station 190 also includes one or more processor(s) 362 and computer-readable storage media 364 (CRM 364). The processor(s) 362 may be single-core processor(s) or multiple-core processor(s) composed of a variety of materials, for example, silicon, polysilicon, high-K dielectric, copper, and so on. CRM 364 may include any suitable memory or storage device such as random-access memory (RAM), static RAM (SRAM), dynamic RAM (DRAM), non-volatile RAM (NVRAM), read-only memory (ROM), or Flash memory useable to store device data 366 of the ground station 190. The device data 366 may include network scheduling data, radio resource management data, beamforming codebooks, applications, and/or an operating system of the ground station 190, which are executable by the processor(s) 362 to enable communication with the NTN BS 160.

The CRM 364 includes a ground station protocol stack 368. The ground station protocol stack 368 may be implemented in whole or part as hardware logic or circuitry integrated with or separate from other components of the ground station 190. The ground station protocol stack 368 may implement any suitable type of communication protocol, such as in a manner similar to the example wireless network stack model 400 described with reference to FIG. 4.

The ground station 190 may include a radio access network interface 370 (RAN interface 370) to implement the interface 115 to the base stations 120. In aspects, the RAN interface 370 is analogous to an Xn or X2 interface between terrestrial base stations. The ground station may also include a core network interface 372 to implement the interface 196 and/or the interface 114 that enables the ground station to communicate with the core network of the non-terrestrial network of the satellite communication network or communicate with a terrestrial core network.

The ground station 190 optionally includes one or more wireless optical transceiver 374 (wireless optical transceiver(s) 374) that can be used to communicate with other devices. To illustrate, the ground station 190 can communicate with an instance of the NTN BS 160 using the wireless optical transceiver 374 as part of the interface 182 or 183.

### Example Protocol Stack

FIG. 4 illustrates an example block diagram of a wireless network protocol stack model 400 (stack 400, network stack 400) that can be used in accordance with various aspects of active coordination sets for non-terrestrial networks. The network stack 400 characterizes an example protocol stack used in terrestrial and/or non-terrestrial communication systems, as shown in the example environment 100. The network stack 400 includes a user plane 402 and a control plane 404. Upper layers of the user plane 402 and the control plane 404 share common lower layers in the network stack 400. Wireless devices, such as the UE 110, the base station 120, the NTN BS 160, and/or the ground station 190, implement each layer as an entity for communication with another device using the protocols defined for the layer. For example, the UE 110 uses a Packet Data Convergence Protocol (PDCP) entity to communicate to a peer PDCP entity in the base station 120 and/or the NTN BS 160 using the PDCP.

The shared lower layers include a physical (PHY) layer 406, a Media Access Control (MAC) layer 408, a Radio Link Control (RLC) layer 410, and a PDCP layer 412. The PHY layer 406 provides hardware specifications for devices that communicate with each other. As such, the PHY layer 406 establishes how devices connect to each other, assists in managing how communication resources are shared among devices and the like.

The MAC layer 408 specifies how data is transferred between devices. Generally, the MAC layer 408 provides a way in which data packets being transmitted are encoded and decoded into bits as part of a transmission protocol.

The RLC layer 410 provides data transfer services to higher layers in the network stack 400. Generally, the RLC layer 410 provides error correction, packet segmentation and reassembly, and management of data transfers in various modes, such as acknowledged, unacknowledged, or transparent modes.

The PDCP layer 412 provides data transfer services to higher layers in the network stack 400. Generally, the PDCP layer 412 provides the transfer of user plane 402 and control plane 404 data, header compression, ciphering, and integrity protection.

Above the PDCP layer 412, the stack splits into the user plane 402 and the control plane 404. Layers of the user plane 402 include an optional Service Data Adaptation Protocol (SDAP) layer 414, an Internet Protocol (IP) layer 416, a Transmission Control Protocol/User Datagram Protocol (TCP/UDP) layer 418, and an application layer 420, which transfers data using various interfaces. The optional SDAP layer 414 is present in 5G NR networks. The SDAP layer 414 maps a Quality of Service (QoS) flow for each data radio bearer and marks QoS flow identifiers in uplink and downlink data packets for each packet data session. The IP layer 416 specifies how the data from the application layer 420 is transferred to a destination node. The TCP/UDP layer 418 is used to verify that data packets intended to be transferred to the destination node reached the destination node, using either TCP or UDP for data transfers by the application layer 420. In some implementations, the user plane 402 may also include a data services layer (not shown) that provides data transport services to transport application data, such as IP packets including web-browsing content, video content, image content, audio content, or social media content.

The control plane 404 includes a Radio Resource Control (RRC) layer 424 and a Non-Access Stratum (NAS) layer 426. The RRC layer 424 establishes and releases connections and radio bearers, broadcasts system information, or performs power control. The RRC layer 424 also controls a resource-control state of the UE 110 and causes the UE 110 to perform operations according to the resource-control state. Example resource-control states include a connected state (e.g., an RRC_CONNECTED state) or a disconnected state, such as an inactive state (e.g., an RRC_INACTIVE state) or an idle state (e.g., an RRC_IDLE state). In general, if the UE 110 is in the connected state, the connection with the base station 120 is active. In the inactive state, the connection with the base station 120 is suspended. If the UE 110 is in the idle state, the connection with the base station 120 is released. Generally, the RRC layer 424 supports 3GPP access but does not support non-3GPP access (e.g., WLAN communications).

The NAS layer 426 provides support for mobility management (e.g., using a Fifth-Generation Mobility Management (5GMM) layer 428) and packet data bearer contexts (e.g., using a Fifth-Generation Session Management (5GSM) layer 430) between the UE 110 and entities or functions in the core network, such as an Access and Mobility Management Function of the 5GC 151 or the like. The NAS layer 426 supports both 3GPP access and non-3GPP access.

In the UE 110, each layer in both the user plane 402 and the control plane 404 of the network stack 400 interacts with a corresponding peer layer or entity in the base station 120, the NTN BS 160, a terrestrial core network entity or function, a non-terrestrial core network entity or function, a ground station, and/or a remote service, to support user applications and control operation of the UE 110 in the RAN 140.

### Example Air Interface Resources

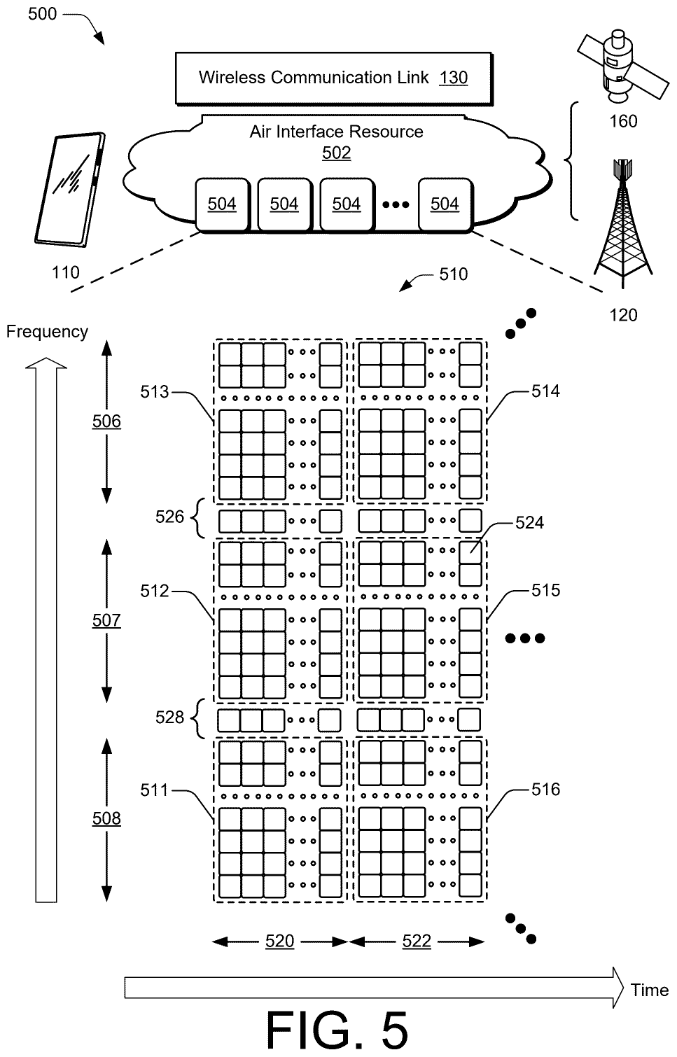

FIG. 5 illustrates an example 500 that includes an example air interface resource 502 that extends between the UE 110 and the base station 120 and/or the NTN BS 160 that can be used to implement various aspects of active coordination sets for non-terrestrial networks. The air interface resource 502 can be divided into resource units 504, each of which occupies some intersection of frequency spectrum and elapsed time. A portion of the air interface resource 502 is illustrated graphically in a grid or matrix having multiple resource blocks 510, including example resource blocks 511, 512, 513, 514, 515, and 516. An example of a resource unit 504, therefore, includes at least one resource block 510. As shown, time is depicted along the horizontal dimension as the abscissa axis, and frequency is depicted along the vertical dimension as the ordinate axis. The air interface resource 502, as defined by a given wireless communication protocol or standard, may span any suitable specified frequency range and/or may be divided into intervals of any specified duration. Increments of time can correspond to, for example, milliseconds (mSec). Increments of frequency can correspond to, for example, megahertz (MHz).

In example operations generally, the base stations 120 and/or a ground station 190 (not illustrated) allocate portions (e.g., resource units 504) of the air interface resource 502 for uplink and downlink communications. Each resource block 510 of network access resources may be allocated to support respective wireless communication links 130 (wireless links 130) of multiple UE 110. In aspects, a base station 120/ground station 190 may schedule one or more resource blocks to a UE 110/NTN BS 160 in accordance with aspects of active coordination sets for non-terrestrial networks. Due to transmission delay and Doppler shift, which experiences more variance in NTNs, a receiver may benefit from time delay/Doppler compensation relative to the resource unit 504 configuration.

In the upper-left corner of the grid, the resource block 513 may span, as defined by a given communication protocol, a first frequency range and/or bandwidth 506 and include multiple subcarriers or frequency sub-bands. In a similar manner, the resource block 514 spans the first frequency range and/or bandwidth 506. The resource block 513 and the resource block 514 may each include any suitable number of subcarriers (e.g., 12) that each corresponds to a respective portion (e.g., 15 kHz) of the specified frequency range or bandwidth 506 (e.g., 180 kHz). In a similar manner, the resource blocks 512 and 515 may span a second frequency range and/or bandwidth 507, and the resource blocks 511 and 516 may span a third frequency range and/or bandwidth 508.

The resource blocks 511, 512, and 513 may also span, as defined by the given communication protocol, a first specified time interval 520 or time slot (e.g., lasting approximately one-half millisecond or 7 orthogonal frequency-division multiplexing (OFDM) symbols in conformance with 3GPP 5G NR standards, numerology 1). The time interval 520 includes subintervals that may each correspond to a symbol, such as an OFDM symbol. In a similar manner, the resource blocks 514, 515, and 516 span a second specified time interval 522. For explanation purposes, the time intervals shown are common across the frequency bandwidths, but implementations may define different time intervals for each frequency bandwidth. As shown in FIG. 5, each resource block 510 may include multiple resource elements 524 (REs) that correspond to, or are defined by, a subcarrier of a frequency range and/or bandwidth (e.g., frequency range and/or bandwidth 507) and a subinterval (or symbol) of a time interval (e.g., the time interval 522). Alternatively, a given resource element 524 may span more than one frequency subcarrier or symbol. Thus, a resource unit 504 may include at least one resource block 510, at least one resource element 524, and so forth.

In aspects of active coordination sets for non-terrestrial networks, a first wireless network, such as a terrestrial-based communication network (e.g., RAN 140), has access to a first set of communication resources, such as the resource blocks 513 and 514. In a similar manner, a second wireless network, such as an NTN communication system (e.g., NTN 170), has access to a second set of communication resources, such as the resource blocks 512 and 515. As another example, a third wireless network has access to a third set of communication resources, such as the resource blocks 511 and 516.

The frequency ranges and/or bandwidths 506 and 507 are separated by a gap or guard band 526, while the frequency ranges and/or bandwidths 507 and 508 are separated by a gap or guard band 528. The frequency bandwidth and/or time duration of the guard band 526 and/or the guard band 528 can correspond to any size of partitioning. As one non-limiting example, the frequency bandwidth of the gap or guard bands 526 and 528 each correspond to a frequency bandwidth associated with a resource element (e.g., RE 524) as shown.

The frequency range and/or bandwidths 506 and 507 are adjacent and the frequency ranges and/or bandwidths 507 and 508 are adjacent based on not being separated by another frequency bandwidth that is occupied by another wireless network. However, the frequency range and/or bandwidth 506 is not adjacent to the frequency range and/or bandwidth 508 based on being separated by the frequency range and/or bandwidth 507 that is occupied by the second wireless network.

### Active Coordination Set

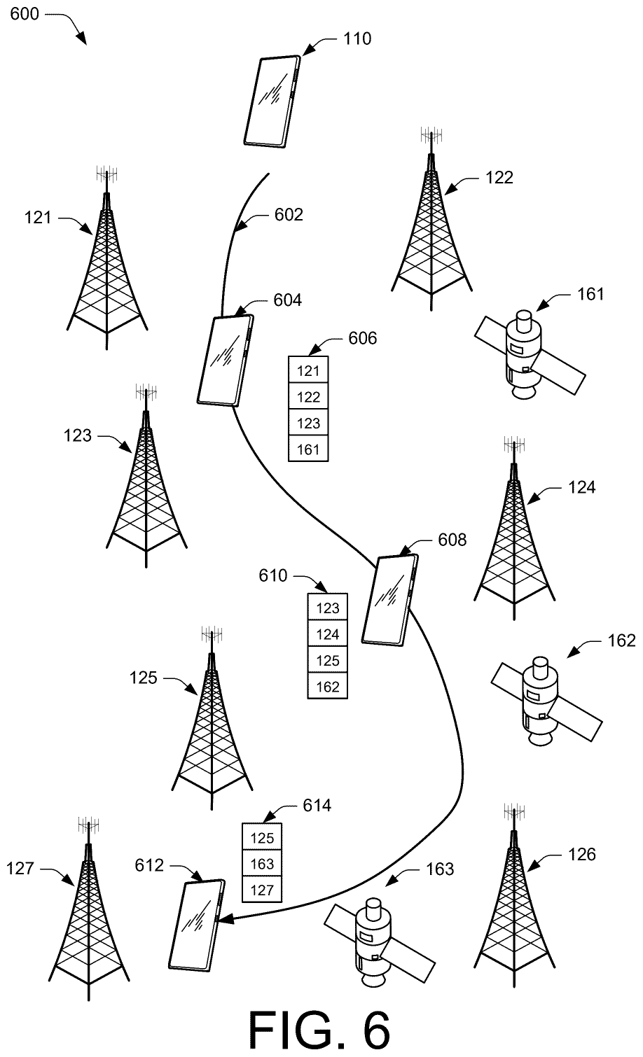

In aspects, an active coordination set for mobility management is described with which the user equipment 110 measures the link quality of candidate base stations 120 and/or NTN BSs 160 to determine which base stations 120 and/or NTN BSs 160 and associated beamforming parameters to include in the ACS. FIG. 6 illustrates an example environment 600 in which a user equipment 110 is moving through a radio access network (RAN) that includes multiple base stations 120, illustrated as terrestrial base stations 121-127 and multiple NTN BSs, illustrated as NTN BS 161-163. These base stations and NTN BSs may utilize different technologies (e.g., LTE, 5G NR, 6G) at a variety of frequencies (e.g., sub-gigahertz, sub-6 GHz, and above 6 GHz bands and sub-bands).

For example, the user equipment 110 follows a path 602 through the RAN 140. The user equipment 110 periodically measures the link quality (e.g., of base stations and/or NTN BSs) that are currently in the ACS and candidate base stations and/or NTN BSs that the UE 110 may add to the ACS. For example, at position 604, the ACS at 606 includes the terrestrial base stations 121, 122, and 123 and NTN BS 161. The UE 110 communicates using joint-transmission and/or joint reception with the terrestrial base stations 121, 122, and 123 and NTN BS 161, while the ACS includes the terrestrial base stations 121, 122, and 123 and NTN BS 161.

As the UE 110 continues to move, at position 608, the UE 110 has deleted terrestrial base station 121, terrestrial base station 122, and NTN BS 161 from the ACS and added terrestrial base stations 124 and 125, and NTN BS 162, as shown at 610. Continuing along the path 602, the UE 110, at position 612, has deleted the terrestrial base stations 123 and 124, and NTN BS 162 and added the terrestrial base station 127 and the NTN BS 163, as shown in the ACS at 614.

### Active Coordination Sets for Non-Terrestrial Networks

An ACS can be formed that includes one or more TN BSs, one or more NTN BSs, or a combination of one or more TN BSs and one or more NTN BSs. When an NTN BS (especially a satellite NTN BS) is included in an ACS with TN BSs, there are different timing delays and Doppler shifts between the UE and the various base stations. Each BS (both TN and NTN) within ACS compensates for the propagation delay and Doppler shift between that specific BS antenna and the UE.

FIG. 7a illustrates an example signaling transaction diagram 700 that includes a combination of actions, signaling transactions, and/or control transactions that can be used to perform aspects of active coordination sets for non-terrestrial networks for forming an ACS that includes TN BS(s) and NTN BS(s). In some aspects, the transactions described with reference to the diagram 900 are implemented using the UE 110, the NTN BS 160, and/or the TN BSs 121 and 122 of FIG. 1.

At 705, the UE 110 selects the TN BS 121 and TN BS 122 to form an ACS based on measurements of candidate BS reference signals. The TN BSs select a coordinating BS for the ACS. For example, the TN BSs select the TN BS 121 to be the coordinating BS for the ACS. If an NTN BS and a TN BS are included in the ACS, it is preferable to select the TN BS as the coordinating BS due to the mobility of the NTN BS. An NTN BS can participate in different ACSs in different time slots, using different frequency resources, and/or using different beams.

At 710, the coordinating TN BS 121 decides whether to propose to include an NTN BS in the ACS. For example, the coordinating TN BS 121 may determine that, based on terrestrial channel conditions between the TN BSs and the UE, or the location of the UE, that including one or more NTN BSs in the ACS might improve communication reliability, throughput, and/or latency for the UE 110. The coordinating TN BS 121 evaluates available ephemeris information for candidates NTN BSs that could be included in the ACS. The ephemeris information can include beam and coverage information so that the coordinating TN BS can determine if there is overlapping coverage between the TN BSs in the ACS with the NTN. In an alternative aspect, the UE 110 can request candidate NTN BS for potential inclusion in the ACS. The UE 110 can decide based on previously obtained ephemeris data or can request ephemeris data for candidate NTN base stations from the coordinating base station 121.

In aspects, the width of a beam from an NTN BS may be much larger than a beam from a TN BS. Accordingly, one NTN BS beam may be used in multiple different ACSs depending on the coverage of the TN BSs that overlap with the NTN BS beam. In another aspect, if an NTN beam is much smaller (e.g., a beam from a HAPS), the NTN BS beam may only be participating in a single ACS at a time. Due to NTN BS mobility, the NTN BSs included in the ACS changes over time. The ACS works transparently with Dual Connectivity (DC) and Carrier Aggregation (CA). For CA, each component carrier can be incorporated into an ACS. For DC, each cell in a Master Cell group (MCG) or a Secondary Cell Group (SCG) can be incorporated into an ACS.

Based on determining to propose a candidate NTN BS in the ACS at 710, the TN BS 121 and the TN BS 122 jointly-transmit ephemeris information for the one or more candidate NTN BSs (e.g., the NTN BS 160) to the UE 110 at 715. For example, the NTN BSs jointly-transmit the ephemeris information in a Radio Resource Control (RRC) message to the UE 110. This transmission of NTN BS ephemeris information differs from neighbor cell satellite assistant information included in the System Information Block 19 (SIB 19) because this ephemeris information uses an RRC message with specific information to account for the specific beam direction for the NTN BS for the UE 110.

At 720, the UE 110 uses the ephemeris information to acquire the SIB1 of at least one of the candidate NTN BSs 160 and measures a Reference Signal Receive Power (RSRP) for at least one of the candidate NTN BSs. At 725, the UE 110 transmits an indication, that is jointly-received by the TN BSs 121 and 122. The indication can be a measurement report, including the RSRP measurement(s) for the candidate base stations and/or an indication of a specific candidate base station to include in the ACS. At 730, based on the received indication, the coordinating TN BS 121 sends an invitation to the NTN BS 160 to join the ACS for the UE 110. The invitation can be sent to the NTN BS 160, as indicated by the UE 110, or based on a selection by the coordinating base station 121 based on the reported measurement results. The coordinating TN BS 121 sends the invitation using the Xn interface 105 or F1 interface 183. The invitation may alternatively be relayed to the NTN BS 160 via any suitable combination of interfaces between the terrestrial core network 150, the non-terrestrial core network 155, and/or the ground station 190.

At 735, the NTN BS 160 sends an indication to the coordinating TN BS that it accepts the invitation. At 740, in response to receiving the acceptance of the invitation, the coordinating TN BS 121 sends UE rough location information to the NTN BS 160. The UE location information can be terrestrial network location service (such as Time Difference of Arrival (TDOA), Round-Trip Time (RTT), and Direction of Arrival (DOA), Angle of Arrival (AOA), and/or UE's Global Navigation Satellite System (GNSS) information. Additionally, alternatively, or optionally, the UE location information can also include information derived from RF channel characteristics of the link between the TN BSs and the UE, such as RSRP, Reference Signal Received Quality (RSRQ), and/or timing advance. In aspects related to CA or DC, the UE location information can be provided on a per cell basis.

In another aspect where an NTN BS is the ACS coordinator, and NTN BS can send an invitation to a TN BS to join the ACS for a UE. In this case, the NTN BS can include UE GNSS information in the invitation to the TN BS.

At 745, the base stations in the ACS have downlink (DL) data for transmission to the UE 110. For example, the coordinating TN BS 121 distributes the downlink data as I/Q data to the other base stations in the ACS.

At 750, the NTN BS 160 precompensates for propagation delay (due to distance differences between the NTN BS and the TN BS(s)) and frequency offset (due to Doppler effects caused by the motion of the NTN BS), as described in greater detail below. At 755, the TN BSs 121 and 122 and the NTN BS 160 jointly-transmit the downlink data to the UE 110 that the UE 110 receives at 760.

At 765, the UE 110 has data for an uplink (UL) transmission. At 770, the UE 110 transmits the uplink data that is jointly-received by the base stations in the ACS. At 775, the NTN BS 160 compensates for timing and frequency offset, as described in greater detail below. At 780, the ACS processes the uplink data with the base stations sending I/Q samples of the received data to the coordinating TN BS 121 that combines the received samples to decode the uplink data.

FIG. 7b illustrates an example signaling transaction diagram 702 that includes a combination of actions, signaling transactions, and/or control transactions that can be used to perform aspects of active coordination sets for non-terrestrial networks for forming an ACS that includes TN BS(s) and NTN BS(s). In some aspects, the transactions described with reference to the diagram 902 are implemented using the UE 110, the NTN BS 160, and/or the TN BSs 121 and 122 of FIG. 1.

Elements 705, 710 are similar to similarly numbered elements in FIG. 7a and, for the sake of brevity, will not be re-described.

Based on determining to propose a candidate NTN BS in the ACS at 710, the TN BS 121 and the TN BS 122 jointly-transmit 785 to the UE 110 ephemeris information, system information, and NTN ACS-specific RACH configuration information to the UE 110 for the one or more candidate NTN BSs (e.g., the NTN BS 160). For example, the existing ACS BSs jointly-transmit the ephemeris information, system information, and NTN ACS-specific RACH configuration information in a Radio Resource Control (RRC) message to the UE 110. This transmission of NTN BS ephemeris information differs from neighbor cell satellite assistant information included in the System Information Block 19 (SIB 19) because this ephemeris information uses an RRC message with specific information to account for the specific beam direction for the NTN BS for the UE 110.

At 790, the UE 110 uses the received information regarding candidate NTN BSs to measure the link quality with the candidate NTN BSs 160 (e.g., measuring RSRP, RSRQ, Signal to Noise and Interference Ratio (SINR), or the like) to determine if any of the candidate NTN BSs 160 is a suitable candidate base station to join the ACS. At 795, based on favorable measurement results for the link with the NTN BS 160, the UE 110 transmits an NTN ACS-specific RACH message to the NTN BS 160 and the coordinating BS 121 and optionally the other ACS BSs (such as TN BS 122) to trigger reformulation of the ACS. Alternatively, the UE 110 can transmit an NTN ACS-specific SRS, to the NTN BS 160 and the coordinating BS 121 and optionally other ACS BSs (such as TN BS 122) to trigger reformulation of the ACS.

Optionally at 740, in response to receiving the NTN ACS-specific RACH message or the NTN ACS-specific SRS, the coordinating TN BS 121 sends UE rough location information to the NTN BS 160. The type of information that can be included in message 740 was described previously with respect to FIG. 7a.

At 745, the base stations in the reformulated ACS have downlink (DL) data for transmission to the UE 110. For example, the coordinating TN BS 121 distributes the downlink data as I/Q data to the other base stations in the ACS.

Elements 750, 755, 760, 765, 770, 775, and 780 are similar to similarly numbered elements in FIG. 7a and, for the sake of brevity, will not be re-described.

In reference to both FIG. 7a and FIG. 7b, an NTN BS can compensate for the frequency offsets (due to Doppler shift) and timing offset for transmission to and receptions from the user equipment 110 for joint ACS processing by using a phase rotator to adjust the frequency offset and adjusting the processing window for the timing offset. The NTN BS handles a large delay offset for timing advance and adjustment of the processing window to allow joint-communication to be possible. This avoids the UE sending UL signals multiple times to complete reception of UL data. In the case where the NTN BS is a HAPS, the round trip time (RTT) may be comparable to the RTT to a TN BS versus a satellite where the RTT is significantly greater than the RTT with a TN BS.

The NTN BS can use the rough location of the UE to estimate a frequency offset and timing offset of the NTN link relative to the TN link which is already synchronized with the TN BSs when the UE is in connected mode. Satellite ephemeris information (such as satellite orbital info, position, speed) can be used to estimate the timing offset and frequency offset between a satellite NTN BS and the UE. The NTN BS needs to compensate for the timing offset and frequency offset that is UE-specific (e.g., depending on the UE location, look angles at the NTN BS, or the like).

Due to the potentially longer propagation delay of the service Uu link between the NTN BS and the UE compared to the Uu link between a TN BS and the UE, the TN BS(s) and the NTN BS(s) coordinate their joint-transmission of the DL signals to reach the UE within the delay tolerance of the UE. To accomplish this, the TN BS(s) and the NTN BS(s) adjust their transmission delays such that the joint-transmission reaches the UE within the same cyclic prefix. In the case of a satellite NTN BS within the ACS, the TN BS(s) within the ACS may need to delay transmission timings more than the NTN BS(s). In the event that the NTN BS is a regenerative NTN BS, timings need to be further adjusted to compensate for processing delay in the regenerative NTN BS as compared to a transparent NTN BS.

For Doppler compensation, the NTN BS precompensates and postcompensates (for the DL and UL, respectively) for a different Doppler effect than experienced at the TN BS. Also, the Doppler shift compensation for a regenerative NTN BS is different from a transparent NTN BS, as the latter has to account for the feeder link Doppler effect as well.

Pre-Doppler compensation by the NTN BS subtracts the Doppler effect such that when the DL signal from the NTN BS reaches to the UE, the frequency of that DL signals matches the DL signal(s) from the TN BS(s). Similarly, the NTN BS performs post-Doppler shift compensation for the UL transmission to compensate based on the orbit and speed of the NTN BS and UE locations.

Due to the delay difference between the NTN BS(s) and the TN BS(s), ACS joint-reception ensures that the I/Q samples from TN BS(s) and NTN BS(s) all correspond to the same UE UL transmit signals. This may require the TN BS(s) and NTN BS(s) to adjust the delay of the I/Q samples between them before combining the UL samples to recover the UL signals.

For transparent NTN BSs, the timing and frequency compensation can be calculated at the ground station 190 as the compensation is largely due to the mobility of the NTN BS as compared to the relatively the low mobility of the UE. UE mobility can be handled in as similar manner as is done in TNs where the subcarrier spacing is much wider than Doppler effect of the UE. For transparent NTN BSs, the joint I/Q processing happens between the ground station 190 and the TN BSs 120. For example, the UL I/Q samples from NTN BS are passed from the ground station 190 to the coordinating TN BS 121.

For regenerative NTN BSs, the timing and frequency compensation can be calculated at the gNB at the NTN BS. The joint I/Q processing happens between the gNB at NTN BS 160 and the TN BSs 121 and 122. The UL I/Q samples from the NTN BS 160 payload are relayed to the coordinating TN BS 121 via the ground station 190.

### Active Coordination Sets Across Multiple Non-Terrestrial Network Cells

In addition to mitigating network coverage issues with an ACS, ACSs can be used to compensate for NTN BS mobility by joint-transmission and joint-reception across multiple NTN BSs and also across a combination of TN BSs and NTN BSs. A coordinating base station (either an NTN BS or TN BS) finds candidate base stations to be members of the ACS. Each NTN BS sets up an NTN ACS-specific Random Access Channel (RACH) configuration that a UE can use to request that the NTN BS join a particular ACS that includes an NTN BS. The coordinating base station provides the UE with the NTN ACS-specific RACH configurations and ephemeris information that enable the UE to measure the link quality of each candidate base station. Based on the measurements, the UE selects a candidate base station and transmits an NTN ACS-specific RACH message to that candidate base station and/or the coordinating base station to begin the process of joining that candidate base station to the ACS. For example, two LEO NTN BSs can coordinate to support an ACS for a specific UE. In another example, a LEO NTN BS and a HAPS NTN BS can coordinate to support an ACS for a UE.

Each NTN BS can configure an NTN ACS-specific RACH configuration that includes specifying air interface resources and a RACH sequence (also called a Random Access preamble). Additionally or alternatively, each NTN BS can configure an NTN ACS-specific sounding reference signal (SRS) configuration. When an NTN BS receives the NTN ACS-specific RACH message or the NTN ACS-specific SRS, that reception can trigger the formation of an ACS by the base stations selected for the ACS.

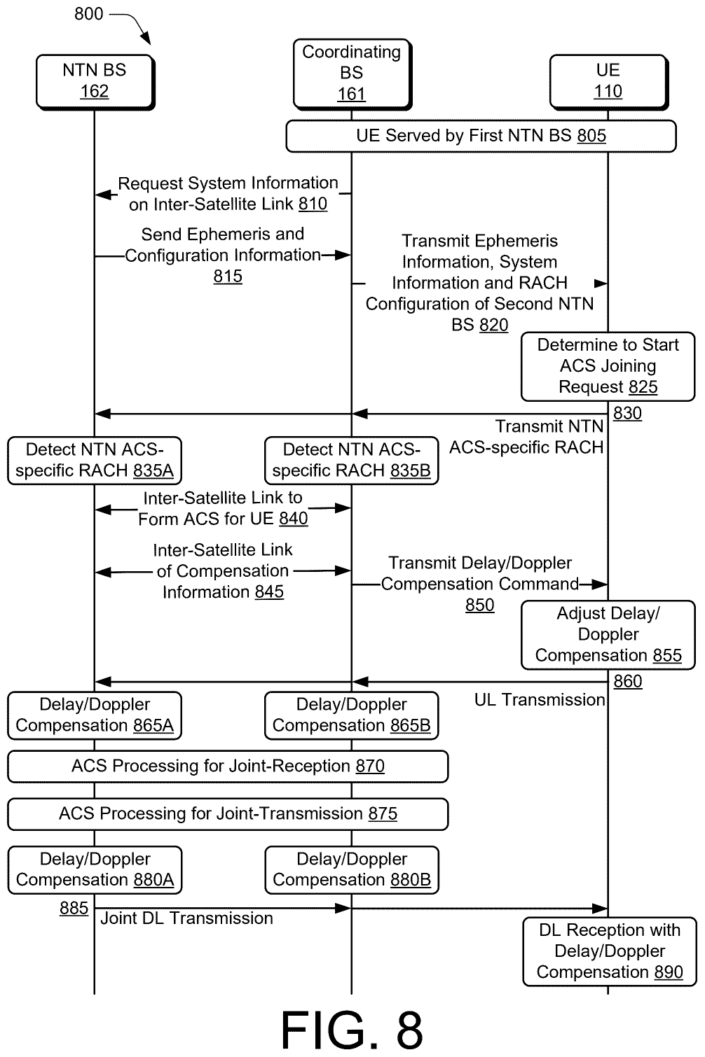

FIG. 8 illustrates an example signaling transaction diagram 800 that includes a combination of actions, signaling transactions, and/or control transactions that can be used to perform aspects of active coordination sets for non-terrestrial networks for forming an ACS across cells provided by NTN BSs. In some aspects, the transactions described with reference to the diagram 800 are implemented using the UE 110, the NTN BS 161, and/or the NTN BS 162 of FIG. 1.

At 805, a first NTN BS (NTN BS 161) serves a cell to the UE 110. Alternatively, a TN BS can serve the UE 110. At 810 and 815, the NTN BS 161 and a second NTN BS (NTN BS 162) communicate to exchange ACS-related information (e.g., via an Xn or F1 interface). For example at 810, NTN BS 161 requests system information (e.g., SIB19 information) from potential ACS candidate BS 162 and, at 815, the NTN BS 162 provides ephemeris information, the requested system information, and NTN ACS-specific RACH information to the NTN BS 161. Based on evaluating ephemeris information received from the NTN BS 162, the NTN BS 161 (acting as a coordinating base station for the ACS) can decide that the NTN BS 162 is a suitable candidate base station for an ACS for the UE 110 (e.g., the NTN BS 161 and the NTN BS 162 share common beam coverage areas) and, at 820, forwards the received ephemeris information, the system information, and NTN ACS-specific RACH configuration information to the UE 110. Additionally, the UE 110 can select the NTN BS 162 for an ACS based on predictions of the movements of the NTN BS 162.

At 825, the UE 110 uses the received information regarding NTN BS 162 to measure the link quality with the NTN BS 162 (e.g., measuring RSRP, RSRQ, Signal to Noise and Interference Ratio (SINR), or the like) to determine if the NTN BS 162 is a suitable candidate base station to join the ACS. At 830, based on favorable measurement results for the link with the NTN BS 162, the UE 110 transmits an NTN ACS-specific RACH message to the NTN BS 161 and the NTN BS 162 to trigger formation of the ACS. Alternatively, the UE 110 can transmit the NTN ACS-specific SRS, to the NTN BS 161 and the NTN BS 162 to trigger formation of the ACS.

At 835A and 835B, the NTN BS 161 and the NTN BS 162 receive the NTN ACS-specific RACH message that is effective to cause the NTN BS 161 and the NTN BS 162 to communicate at 840 (e.g., over an Xn of F1 interface) to establish the ACS. Alternatively, the NTN BS 161 and the NTN BS 162 receive the NTN ACS-specific SRS from the UE 110 that triggers formation of the ACS.

At 845, the coordinating NTN BS 161 facilitates communication with the NTN BS 162 to determine how timing and frequency compensation will be handled in the ACS. For example, for UL communication, the UE 110 may be instructed (at 850) to not compensate for the Doppler shift with each NTN BS within the ACS individually compensating for the Doppler shift before passing the I/Q samples of the UL signals to the coordinating NTN BS for joint-reception processing. In another example, for UL communication the UE 110 may be instructed at (850) to compensate for a common portion of timing delay and/or Doppler shift for the involved NTN BSs in the ACS, with each NTN BS in ACS compensating for the remaining portion of the timing delay and/or Doppler shift. In a further example, for downlink communication, the coordinating BS determines how much each NTN BS of the ACS will compensate in the DL. As long as the timing difference is within the same cyclic prefix, UE can compensate for the remaining portion of the compensation.

Based on the received delay/Doppler compensation command, at 855, the UE 110 configures adjustments for the delay/Doppler compensation for UL and/or DL communications. At 860, the UE 110 transmits the uplink data that is jointly-received by the base stations (NTN BS 161 and NTN BS 162) in the ACS. At 865A and 865B, the NTN BS 161 and the NTN BS 162 compensate for timing and frequency offset for delay and Doppler compensation, respectively. At 870, the ACS processes the uplink data with the NTN BSs sending I/Q samples of the received data to the coordinating NTN BS 161 that combines the received samples to decode the uplink data.

At 875, the base stations in the ACS have downlink (DL) data for transmission to the UE 110. For example, the coordinating NTN BS 161 distributes the downlink data as I/Q samples to the other base stations in the ACS. At 880A and 880B, the NTN BS 161 and the NTN BS 162 compensate for timing and frequency offset for delay and Doppler compensation, respectively. At 885, the NTN BSs 161 and 162 jointly-transmit the downlink data to the UE 110 and, at 890, the UE 110 applies delay and Doppler compensation to the DL data received from the NTN BS 161 and the NTN BS 162.

In a further aspect, the coordinating base station 121 can further evaluate ephemeris information to identify further NTN BSs as candidate base stations to add to the ACS, especially as NTN BSs currently in an ACS may travel out of view of the UE 110. The coordinating BS 121 then jointly-transmits the ephemeris information to the UE 110 as described at 715 and the process of evaluating and inviting one or more further NTN BSs continues as described with respect to FIG. 7.

In another aspect, the coordinating BS 161 can further evaluate ephemeris information to identify other NTN BSs as candidate base stations to add to the ACS, as well as evaluating changing UE location information that may indicate that there are TN BSs that are candidate BSs for the ACS. If the UE 110 and/or the coordinating BS 161 determine that there is sufficient coverage available from candidate TN BSs, the TN BSs may be added to the ACS and the NTN BSs, including the coordinating BS 161, may leave the ACS. The coordination of the ACS is then transferred to one of the TN BSs in the ACS.

### Example Methods

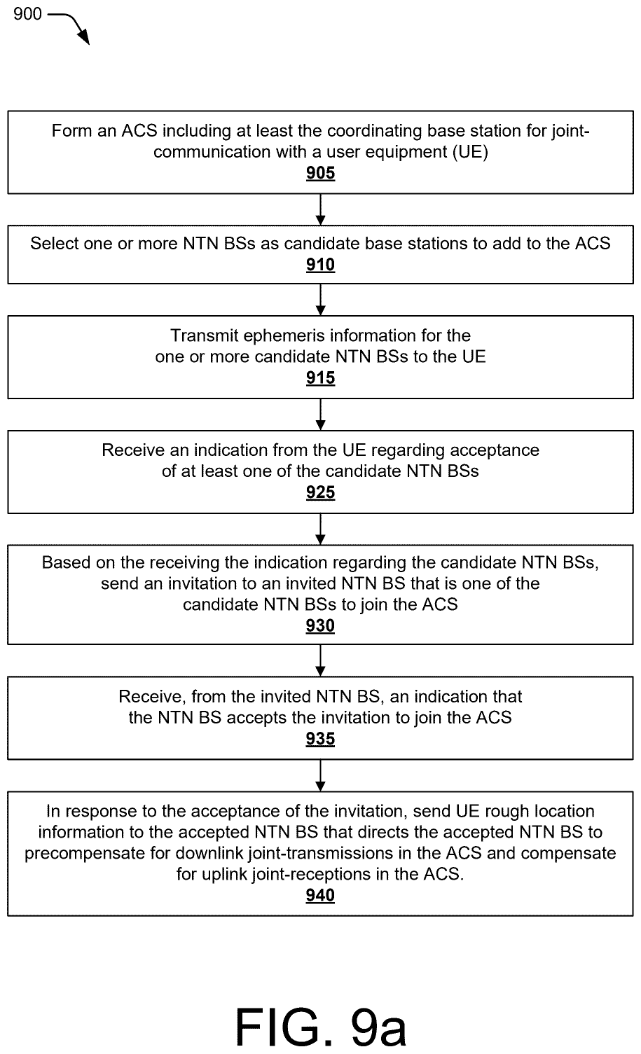

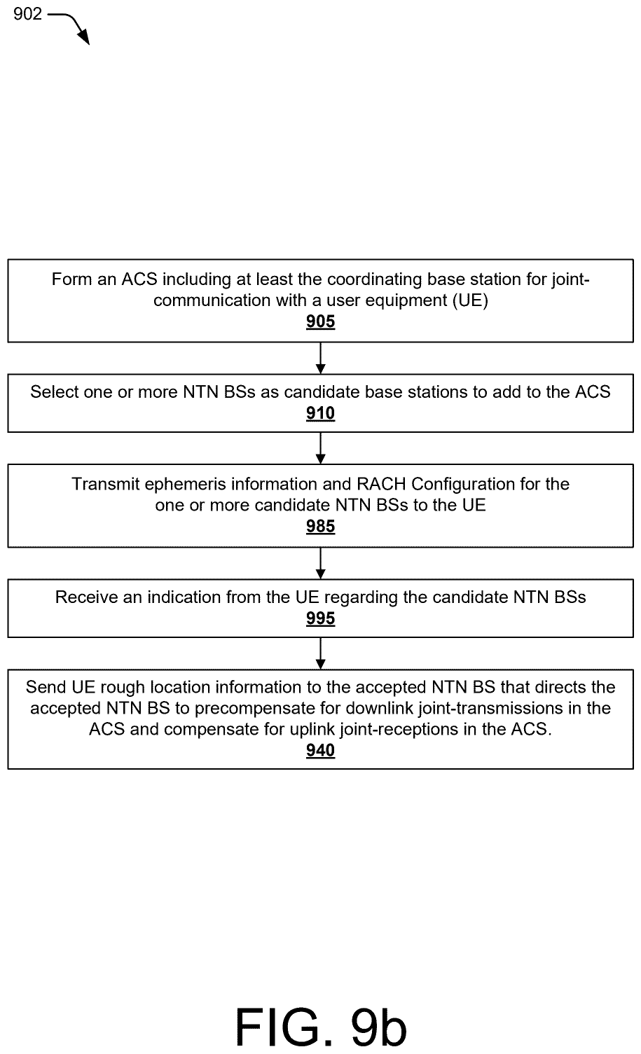

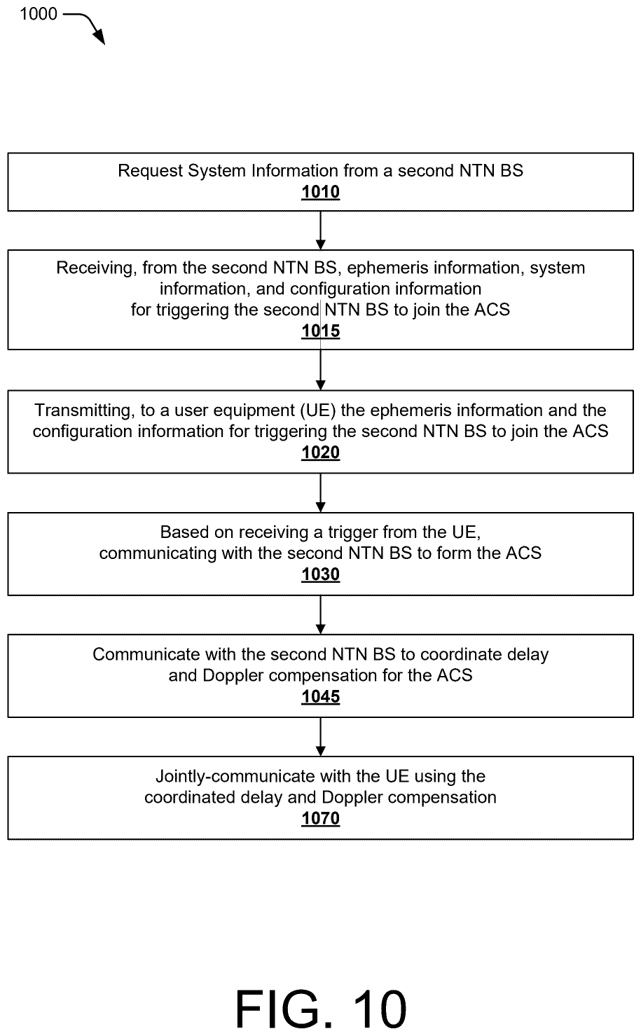

Example methods 900, 902, and 1000 are described with reference to FIGS. 9a, 9b, and 10 in accordance with one or more aspects of active coordination sets for non-terrestrial networks. The example method 900 in FIG. 9a used to perform aspects of active coordination sets for non-terrestrial networks may be performed by one or more entities of a terrestrial communication system and a non-terrestrial communication system, such as terrestrial network base station (e.g., TN BS 120), a non-terrestrial base station (e.g., an NTN BS 160), and/or a ground station (e.g., the ground station 190) of FIG. 1

At 905, a terrestrial or non-terrestrial network base station acting as a coordinating base station for an ACS forms an ACS, including at least the coordinating base station, for joint-communication with a UE. For example, a terrestrial network base station (e.g., the TN BS 121), acting as a coordinating base station (e.g., coordinating base station 121) for an ACS, forms an ACS including at least the coordinating base station for joint-communication with a UE (e.g., the UE 110) as described at FIG. 7a element 705.

At 910, the coordinating base station selects one or more NTN BSs as candidate base stations to present to the UE as a potential ACS BS. For example, based on an evaluation of terrestrial channel conditions for the UE and ephemeris information for available NTN BSs (e.g., the NTN BSs 160), the coordinating BS 121 selects one or more base stations (e.g., the NTN BS 161) as available to add to the ACS as described at FIG. 7a element 710.

At 915, the coordinating base station transmits ephemeris information for the one or more candidate NTN BSs to the UE. For example, the coordinating base station 121 transmits ephemeris information for the one or more NTN BSs 160 to the UE 110, the transmission usable by the UE 110 to acquire the SIB1 and measure a signal quality (e.g., RSRP) of one or more candidate NTN BSs 160 as described in FIG. 7a at 715 and 720. Optionally or additionally, the UE 110 selects the candidate NTN BS 160 to add to the ACS.

At 925, the coordinating base station receives an indication from the UE regarding acceptance of at least one of the candidate NTN BSs. For example, the coordinating base station 121 receives a measurement report from the UE 110 for the measurement of signal quality of one or more candidate NTN BSs 160 as described in FIG. 7a at 725. Alternatively, the coordinating base station 121 receives an indication of one of the candidate NTN BSs to add to the ACS.

At 930, the coordinating base station, based on the receiving the indication regarding the candidate NTN BSs, sends an invitation to an NTN BS that is one of the candidate NTN BSs to join the ACS. For example, the coordinating base station 121, based on the receiving the indication, sends an invitation to an NTN BS 160 to join the ACS as described at 730 in FIG. 7a.

At 935, the coordinating base station receives, from the invited NTN BS, an indication that the invited NTN BS accepts the invitation to join the ACS. For example, the coordinating base station 121 receives, from the NTN BS 160, an indication that the NTN BS 160 accepts the invitation to join the ACS as described at 735 in FIG. 7a.

At 940, the coordinating base station, in response to the acceptance of the invitation, sends UE rough location information to the accepted NTN BS that directs the accepted NTN BS to precompensate for downlink joint-transmissions in the ACS and compensate for uplink joint-receptions in the ACS. For example, the coordinating base station 121, in response to the acceptance of the invitation, sends UE rough location information to the NTN BS 160 that directs the NTN BS 160 to precompensate for downlink joint-transmissions in the ACS and compensate for uplink joint-receptions in the ACS, as described in FIG. 7a at 750-780.

The example method 902 in FIG. 9b used to perform aspects of active coordination sets for non-terrestrial networks may be performed by one or more entities of a terrestrial communication system and a non-terrestrial communication system, such as terrestrial network base station (e.g., TN BS 120), a non-terrestrial base station (e.g., an NTN BS 160), and/or a ground station (e.g., the ground station 190) of FIG. 1

At 905, a terrestrial or non-terrestrial network base station acting as a coordinating base station for an ACS forms an ACS, including at least the coordinating base station, for joint-communication with a UE. For example, a terrestrial network base station (e.g., the TN BS 121), acting as a coordinating base station (e.g., coordinating base station 121) for an ACS, forms an ACS including at least the coordinating base station for joint-communication with a UE (e.g., the UE 110) as described at FIG. 7b element 705.

At 910, the coordinating base station selects one or more NTN BSs as candidate base stations to present to the UE as a potential ACS BS. For example, based on an evaluation of terrestrial channel conditions for the UE and ephemeris information for available NTN BSs (e.g., the NTN BSs 160), the coordinating BS 121 selects one or more base stations (e.g., the NTN BS 161) as available to add to the ACS as described at FIG. 7b element 710.

At 985, the coordinating base station transmits ephemeris information and NTN ACS-specific RACH configuration for the one or more candidate NTN BSs to the UE. For example, the coordinating base station 121 transmits ephemeris information and NTN ACS-specific RACH configuration for the one or more NTN BSs 160 to the UE 110, the transmission usable by the UE 110 to acquire the SIB1 and measure a signal quality (e.g., RSRP) of each of the one or more NTN BSs 160 as described in FIG. 7b at 785 and 790 to enable the UE 110 to select the candidate NTN BS 160 to add to the ACS.

At 995, the coordinating base station receives an indication from the UE regarding the candidate NTN BSs. For example, the UE 110 transmits the NTN ACS-specific RACH or an NTN ACS-specific SRS that is received by the coordinating base station, the candidate NTN BS 160, and optionally another BS participating in the ACS, that indicates that the UE 110 has added the candidate NTN BS 160 to the ACS, as indicated in FIG. 7b at 795.

At 940, the coordinating base station, sends UE rough location information to the accepted NTN BS that directs the accepted NTN BS to precompensate for downlink joint-transmissions in the ACS and compensate for uplink joint-receptions in the ACS. For example, the coordinating base station 121, in response to the acceptance of the invitation, sends UE rough location information to the NTN BS 160 that directs the NTN BS 160 to precompensate for downlink joint-transmissions in the ACS and compensate for uplink joint-receptions in the ACS, as described in FIG. 7b at 750-780.

The example method 1000 used to perform aspects of active coordination sets for non-terrestrial networks may be performed by one or more entities of a terrestrial communication system and a non-terrestrial communication system, such as terrestrial network base station (e.g., TN BS 120), a non-terrestrial base station (e.g., an NTN BS 160), and/or a ground station (e.g., the ground station 190) of FIG. 1. At 1010, a first NTN BS acting as a coordinating base station for an ACS requests system information (e.g., System Information Block 19 (SIB 19) information) from a second NTN BS. For example, a first NTN BS (e.g., NTN BS 161) acting as a coordinating base station for an ACS requests system information (such as System Information Block 19 (SIB 19) information) from a second NTN BS (e.g., NTN BS 162) over an Xn or F1 interface as described at 810 in FIG. 8.

At 1015, the coordinating BS receives, from the second NTN BS, ephemeris information, system information, and configuration information for triggering the second NTN BS to join the ACS. For example, the first NTN BS 161 receives, from the second NTN BS 162, ephemeris information, system information, and configuration information for triggering the second NTN BS 162 to join the ACS as described at 815 in FIG. 8. In aspects, configuration information includes a configuration for an NTN ACS-specific RACH or a configuration for an ACS-specific sounding reference signal.

At 1020, the coordinating BS transmits, to a user equipment, the ephemeris information and the configuration information for triggering the second NTN BS to join the ACS. For example, the first NTN BS 161 transmits, over the Uu interface to a user equipment (e.g., UE 110), the ephemeris information and the configuration information for triggering the second NTN BS 162 to join the ACS as described at 820 in FIG. 8.

At 1030, based on receiving a trigger from the UE conforming to the configuration information for triggering the second NTN BS to join the ACS, the coordinating BS communicates with the second NTN BS to form the ACS. For example, based on receiving a RACH message A from the UE that uses the ACS-specific RACH preamble (or an ACS-specific SRS) indicated in the configuration information, the first NTN BS 161 and the second NTN BS 162 communicate to form the ACS as described at 830 and 835 in FIG. 8.

At 1045, the first NTN BS communicates with the second NTN BS to coordinate delay and Doppler compensation for the ACS. For example, the first NTN BS 161 communicates with the second NTN BS 162 to coordinate delay and Doppler compensation for the ACS, such as determining what portion of the compensation will be performed at the NTN BSs and if a portion of the compensation will be performed by the UE 110, as described at 845 in FIG. 8.

At 1070, the first NTN BS jointly-communicates with the UE using the coordinated delay and Doppler compensation. For example, the first NTN BS 161 and the NTN BS 162 jointly-communicate with the UE 110 using the coordinated delay and Doppler compensation as described at 860-885 in FIG. 8

The order in which the method blocks of the methods 900 and 1000 are described is not intended to be construed as a limitation, and any number of the described method blocks can be skipped or combined in any order to implement a method or an alternative method. Any blocks of the methods 900 and 1000 can be combined to implement a method for a coordination base station in an ACS. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or additionally, any of the functionality described herein can be performed, at least in part, by one or more hardware logic components, such as, and without limitation, Field-Programmable Gate Arrays (FPGAs), Application-Specific Integrated Circuits (ASICs), Application-Specific Standard Products (ASSPs), System-on-Chip systems (SoCs), Complex Programmable Logic Devices (CPLDs), and the like.

In the following some examples are described:

Example 1: A method for forming an Active Coordination Set (ACS) including a non-terrestrial network (NTN) base station (BS) by a coordinating base station, the method comprising:
forming an ACS including at least the coordinating base station for joint-communication with a user equipment (UE);
selecting one or more NTN BSs as candidate NTN BSs to add to the ACS;
transmitting ephemeris information for the one or more candidate NTN BSs to the UE;
receiving an indication from the UE regarding acceptance of at least one of the candidate NTN BSs; and
sending UE rough location information to an accepted NTN BS that directs the accepted NTN BS to precompensate for downlink joint-transmissions in the ACS and compensate for uplink joint-receptions in the ACS.

Example 2: The method of example 1, wherein the coordinating base station is a first terrestrial network (TN) BS, and wherein the ACS includes a second TN BS, wherein the transmitting the ephemeris information for the one or more NTN BSs to the UE comprises:
jointly-transmitting the ephemeris information to the UE by the first TN BS and the second TN BS.

Example 3: The method of example 2, wherein the selecting one or more NTN BSs as candidate base stations to add to the ACS comprises:
selecting to add the one or more NTN BSs based on channel conditions between the coordinating BS and the UE, channel conditions between other BSs in the ACS, and/or the location of the UE.

Example 4: The method of any one of the preceding examples, wherein the selecting of the one or more NTN BSs as candidate base stations to add to the ACS is based on improving one or more of:
communication reliability for the UE;
increasing communication throughput for the UE; or
reducing communication latency for the UE.

Example 5: The method of any one of the preceding examples, comprising:
based on the receiving the indication regarding acceptance of at least one of the candidate NTN BSs,
sending an invitation to the at least one of the candidate NTN BSs to join the ACS;
receiving, from the invited NTN BS, an indication that the invited NTN BS accepts the invitation to join the ACS; and
in response to the acceptance of the invitation, sending the UE rough location information to the accepted NTN BS that directs the accepted NTN BS to precompensate for downlink joint-transmissions in the ACS and compensate for uplink joint-receptions in the ACS.

Example 6: The method of example 5, wherein the sending the invitation to the at least one of the candidate NTN BSs to join the ACS comprises:
using an Xn interface or an F1 interface to send the invitation; and
wherein the receiving, from the invited NTN BS, the indication that the invited NTN BS accepts the invitation to join the ACS comprises:
receiving, from the NTN BS and over the Xn or F1 interface, the indication that the invited NTN BS accepts the invitation to join the ACS.

Example 7: The method of example 1, wherein the indication from the UE regarding acceptance of at least one of the candidate NTN BSs comprises:
a measurement report from the UE, and wherein the measurement report includes a Reference Signal Receive Power (RSRP) measurement for at least one of the candidate NTN BSs.

Example 8: The method of example 7, wherein the sending of the invitation to the at least one of the candidate NTN BSs to join the ACS comprises:
evaluating the measurement report to select the at least one of the candidate NTN BSs to invite to join the ACS.

Example 9: The method of any one of the preceding examples, wherein the sending of the UE rough location information to the accepted NTN BS that directs the NTN BS to precompensate for downlink joint-transmissions in the ACS configures the NTN BS to:
adjust a timing offset for transmissions based on a location of the NTN BS; or
adjust a frequency offset based on relative motion between the UE and NTN BS.

Example 10: The method of example 9, wherein the adjustment of the precompensation causes the transmission from the TN BSs and the NTN BS to arrive at the UE during a same cyclic prefix.

Example 11: The method of any one of the preceding examples, comprising:
jointly-transmitting, with the NTN BS, downlink data to the UE; or
jointly-receiving, with the NTN BS, uplink data from the UE.

Example 12: The method of example 1, wherein the coordinating base station is a first non-terrestrial network (NTN) BS, and wherein the ACS includes a second NTN BS.

Example 13: The method of example 12, the method comprising:
requesting system information from the second NTN BS;
receiving, from the second NTN BS, ephemeris information, system information, and configuration information for triggering the second NTN BS to join the ACS;
transmitting, to a user equipment (UE), the ephemeris information and the configuration information for triggering the second NTN BS to join the ACS;
based on receiving a trigger from the UE, communicating with the second NTN BS to form the ACS;
communicating with the second NTN BS to coordinate delay and Doppler compensation for the ACS; and
jointly-communicating with the UE using the coordinated delay and Doppler compensation.

Example 14: The method of example 13, wherein the configuration information for triggering the second NTN BS to join the ACS comprises a configuration for an NTN ACS-specific RACH, and wherein a configuration for the NTN ACS-specific RACH includes an indication of air interface resources for the NTN ACS-specific RACH and a sequence for the NTN ACS-specific RACH.

Example 15: The method of example 14, wherein the receiving the trigger comprises:
receiving the NTN ACS-specific RACH sequence from the UE.

Example 16: The method of example 13, wherein the configuration information for triggering the second NTN BS to join the ACS comprises a configuration for an ACS-specific sounding reference signal.

Example 17: The method of example 16, wherein the receiving the trigger comprises:
receiving the ACS-specific sounding reference signal from the UE.

Example 18: The method of any one of examples 13 to 17, comprising:
transmitting a compensation command to the UE that directs the UE to perform a portion of the delay or Doppler compensation during joint-communication with the ACS.

Example 19: The method of example 13, wherein the transmitting, to a user equipment (UE), the ephemeris information and the configuration information for triggering the second NTN BS to join the ACS comprises:
jointly-transmitting, to the UE, the ephemeris information and the configuration information for triggering the second NTN BS to join the ACS.

Example 20: The method of example 13, wherein based on the receiving the trigger from the UE, communicating with the second NTN BS to form the ACS comprises:
based on jointly-receiving the trigger from the UE, communicating with the second NTN BS to form the ACS.

Example 21: The method of any one of examples 1 to 6 and 9 to 20, wherein the receiving of the indication from the UE regarding the candidate NTN BSs comprises:
receiving an indication identifying one of the candidate NTN BSs to add to the ACS.

Example 22: The method of any one of the preceding examples, wherein the receiving the indication from the UE regarding the acceptance of the at least one of the candidate NTN BSs comprises:
jointly-receiving the indication from the UE regarding the acceptance of the at least one of the candidate NTN BSs.

Example 23: A base station (BS) comprising:
one or more radio frequency transceivers; and
a processor and memory system to implement an active coordination set (ACS) manager application configured to perform any one of methods of any one of examples 1 to 22.

Example 24: The base station of example 23, wherein the base station is a terrestrial network (TN) BS or the base station is a non-terrestrial network (NTN) BS.

Although aspects of active coordination sets for non-terrestrial networks have been described in language specific to features and/or methods, the subject matter of this disclosure is not necessarily limited to the specific features or operations described. Rather, the specific features and methods are disclosed as example implementations of active coordination sets for non-terrestrial networks, and other equivalent features and operations are intended to be within the scope of the described subject matter. It is to be appreciated that each described aspect can be implemented independently or in connection with one or more other described aspects.

1. A method for forming an Active Coordination Set (ACS) including a non-terrestrial network (NTN) base station (BS) by a coordinating base station, the method comprising:
forming an ACS including at least the coordinating base station for joint-communication with a user equipment (UE);
selecting one or more NTN BSs as candidate NTN BSs to add to the ACS;
transmitting ephemeris information for the one or more candidate NTN BSs to the UE;
receiving an indication from the UE regarding acceptance of at least one of the candidate NTN BSs; and
sending UE rough location information to an accepted NTN BS that directs the accepted NTN BS to precompensate for downlink joint-transmissions in the ACS and compensate for uplink joint-receptions in the ACS.

2. The method of claim 1, wherein the coordinating base station is a first terrestrial network (TN) BS, and wherein the ACS includes a second TN BS, wherein the transmitting the ephemeris information for the one or more NTN BSs to the UE comprises:
jointly-transmitting the ephemeris information to the UE by the first TN BS and the second TN BS.

3. The method of claim 2, wherein the selecting one or more NTN BSs as candidate base stations to add to the ACS comprises:
selecting to add the one or more NTN BSs based on channel conditions between the coordinating BS and the UE, channel conditions between other BSs in the ACS, and/or the location of the UE.

4. The method of claim 1, wherein the selecting of the one or more NTN BSs as candidate base stations to add to the ACS is based on improving one or more of:
communication reliability for the UE;
increasing communication throughput for the UE; or
reducing communication latency for the UE.

5. The method of claim 1, comprising:
based on the receiving the indication regarding acceptance of at least one of the candidate NTN BSs,
sending an invitation to the at least one of the candidate NTN BSs to join the ACS;
receiving, from the invited NTN BS, an indication that the invited NTN BS accepts the invitation to join the ACS; and
in response to the acceptance of the invitation, sending the UE rough location information to the accepted NTN BS that directs the accepted NTN BS to precompensate for downlink joint-transmissions in the ACS and compensate for uplink joint-receptions in the ACS.

6. The method of claim 1 wherein the indication from the UE regarding acceptance of at least one of the candidate NTN BSs comprises:
a measurement report from the UE, and wherein the measurement report includes a Reference Signal Receive Power (RSRP) measurement for at least one of the candidate NTN BSs.

7. The method of claim 1, wherein an adjustment of the precompensation causes the transmission from the TN BSs and the NTN BS to arrive at the UE during a same cyclic prefix.

8. The method of claim 1, comprising:
jointly-transmitting, with the NTN BS, downlink data to the UE; or
jointly-receiving, with the NTN BS, uplink data from the UE.

9. The method of claim 1, wherein the coordinating base station is a first non-terrestrial network (NTN) BS, and wherein the one or more candidate NTN BSs include a second NTN BS.

10. The method of claim 9, the method comprising:
requesting system information from the second NTN BS;
receiving, from the second NTN BS, additional ephemeris information, system information, and configuration information for triggering the second NTN BS to join the ACS;
transmitting, to the user equipment (UE), the additional ephemeris information and the configuration information for triggering the second NTN BS to join the ACS;
based on receiving a trigger from the UE, communicating with the second NTN BS to form the ACS;
communicating with the second NTN BS to coordinate delay and Doppler compensation for the ACS; and
jointly-communicating with the UE using the coordinated delay and Doppler compensation.

11. The method of claim 10, wherein the configuration information for triggering the second NTN BS to join the ACS comprises a configuration for an NTN ACS-specific RACH, and wherein a configuration for the NTN ACS-specific RACH includes an indication of air interface resources for the NTN ACS-specific RACH and a sequence for the NTN ACS-specific RACH.

12. The method of claim 11, wherein the configuration information for triggering the second NTN BS to join the ACS comprises a configuration for an ACS-specific sounding reference signal.

13. The method of claim 10, comprising:
transmitting a compensation command to the UE that directs the UE to perform a portion of the delay or Doppler compensation during joint-communication with the ACS.

14. The method of claim 1, wherein the receiving of the indication from the UE regarding the candidate NTN BSs comprises:
receiving an indication identifying one of the candidate NTN BSs to add to the ACS.

15. The method of claim 1, wherein the receiving the indication from the UE regarding the acceptance of the at least one of the candidate NTN BSs comprises:
jointly-receiving the indication from the UE regarding the acceptance of the at least one of the candidate NTN BSs.

16. A base station comprising:
one or more radio frequency transceivers; and
a processor; and
memory comprising instructions executable to implement an active coordination set (ACS) manager application that configures the base station (BS) to perform as a coordinating base station, the coordinating BS configured to:
form an ACS including at least the coordinating base station for joint-communication with a user equipment (UE);
select one or more NTN BSs as candidate NTN BSs to add to the ACS;
transmit ephemeris information for the one or more candidate NTN BSs to the UE;
receive an indication from the UE regarding acceptance of at least one of the candidate NTN BSs; and
send UE rough location information to an accepted NTN BS that directs the accepted NTN BS to precompensate for downlink joint-transmissions in the ACS and compensate for uplink joint-receptions in the ACS.

17. The base station of claim 16, wherein the coordinating base station is a first terrestrial network (TN) BS, and wherein the ACS includes a second TN BS, wherein the instructions to transmit the ephemeris information for the one or more NTN BSs to the UE are further executable to configure the coordinating base station to:
jointly-transmit the ephemeris information to the UE by the first TN BS and the second TN BS.

18. The base station of claim 17, wherein the instructions to select the one or more NTN BSs as candidate base stations to add to the ACS are further executable to configure the coordinating base station to:
select to add the one or more NTN BSs based on channel conditions between the coordinating BS and the UE, channel conditions between other BSs in the ACS, and/or the location of the UE.

19. The base station of claim 16, wherein the selection of the one or more NTN BSs as candidate base stations to add to the ACS is based on improving one or more of:
communication reliability for the UE;
increasing communication throughput for the UE; or
reducing communication latency for the UE.

20. The base station of claim 16, wherein the base station is a terrestrial network (TN) BS or the base station is a non-terrestrial network (NTN) BS.
